(19) United States
(12) Patent Application Publication
(10) Pub. No.: US 2025/0068142 A1
(43) Pub. Date: Feb. 27, 2025

(54) AI SYSTEM AND METHOD FOR PARTS AND MANUFACTURER MATCHING BASED ON MANUFACTURING CAPABILITY MODELS

(71) Applicant: Georgia Tech Research Corporation, Atlanta, GA (US)

(72) Inventors: Shreyes N. Melkote, Roswell, GA (US); David William Rosen, Atlanta, GA (US); Zhichao Wang, Atlanta, GA (US); Xiaoliang Yan, Atlanta, GA (US)

(21) Appl. No.: 18/749,047

(22) Filed: Jun. 20, 2024

Related U.S. Application Data
(60) Provisional application No. 63/520,869, filed on Aug. 21, 2023.

(51) Int. Cl. G05B 19/4093; G05B 19/4097; G06F 16/903

(52) U.S. Cl. CPC G05B 19/40932; G05B 19/4097; G06F 16/90335

(57) ABSTRACT

An exemplary system and method are disclosed for a shape similarity search via a trained AI model configured on both part shape and material properties, among others, to allow for searching against a database of parts to identify a set of candidate like models or parts. In some embodiments, the trained AI model can learn the capabilities of a manufacturing facilities to which the trained AI model can be interrogated to identify a candidate manufacturer for a given part having both part shape and material properties. The operation can be performed via federated learning for improved privacy.

### RELATED APPLICATION

This U.S. Patent application claims priority to, and the benefit of, U.S. Provisional Patent Application No. 63/520,869, filed Aug. 21, 2023, entitled “A MULTIMODEL MANUFACTURED PARTS DATABASE CREATION AND EFFICIENT PART RETRIEVAL METHOD,” which is incorporated by reference herein in its entirety.

### STATEMENT REGARDING FEDERALLY SPONSORED RESEARCH OR DEVELOPMENT

This invention was made with government support under grant no. 2113672 awarded by the National Science Foundation and grant no. 2229260 awarded by the National Science Foundation. The government has certain rights in the invention.

### BACKGROUND

Manufacturing and design can be expedited by re-using parts that have been previously manufactured and/or designed. For example, a part can be re-used in its entirety or used as a starting point for the manufacture or design of another part. Part re-use for manufacturing and design can be limited by difficulties in finding similar parts with similar shapes and materials. Manual searching and indexing of parts can be time-consuming and can become cost-prohibitive at scale. Improvements in searching for parts can be beneficial to design and manufacturing processes.

There is a benefit to searching and identifying existing parts in a database.

### SUMMARY

An exemplary system and method are disclosed for a shape and property similarity search via a trained AI model (e.g., employing an autoencoder) configured with both (i) part geometric shape and (ii) part properties or other manufacturability-associated properties to allow for searching against a database embedded in the trained AI model to identify a set of candidate like models or parts. In some embodiments, from the parts and property-based training, the trained AI model can learn the capabilities of manufacturing facilities to which the trained AI model can be interrogated to identify a candidate manufacturer for a new part based on both the part shape and material or manufacturability-associated properties.

The exemplary system and method can be employed in the automated identification of suitable manufacturing process(es) for a given discrete part design via a multimodal and automatically constructed manufacturing parts database as well as an automated part retrieval method. The exemplary system can automatically create a multimodal parts-embedded database by associating geometric data describing mechanical parts and part properties or other manufacturability-associated properties as a latent vectorial representation embedded with the AI model, for efficient search and retrieval.

The exemplary system and method may perform federated collaborative learning to additionally provide privacy capabilities that allow multiple federated members to share an aspect of its trained model, e.g., gradients and weights, with other members to respectively incorporate into its respective local model without having to share raw data.

The term “part geometric shape,” “part shape,” or “shape” refers to a 3D or 2D engineering design of a part or an assembly from computer-aided design (CAD) files or engineering drawings. The terms “part” and “assembly” are interchangeably used herein, as an assembly includes multiple parts that are assembled together. Parts and assemblies can include and are not limited to metalworking parts, woodworking parts, partially assembled construction components, plastic fabrication/or forming/molding, glasswork parts, eyewear and contact lens, furniture and subassemblies, printed circuit boards, flexible circuit boards, semiconductor devices and parts, semiconductor packaging and/or assembly, electrical components such as photovoltaics, power supplies, power converters, switchgear for power distribution and/or transmission, vehicle components such as batteries, chassis, seats, wheels, and various parts.

The term “part property,” as used herein, refers to a non-geometric part specification for a part or an assembly and can include the material of the part, surface finish, and dimensional tolerances associated with the part/design. Material part properties can include material density, tensile strength, and melting point, among others.

The term “manufacturability associated property,” as used herein, refers to manufacturability metadata-data that provides information about the manufacturing or manufacturer's process not directed to the part design itself—of a manufacturer. Examples of manufacturability associated property/metadata include manufacturing process or tool (e.g., cast, stamped, extruded, 3D-printed), quality indication (e.g., quality KPI or metrics), use of lean manufacturing, manufacturing time for a design, cost of manufacturing of the part, scale-of-production such as whether the part was manufactured in batch or the associated size of the batch, machines/equipment on which the part was made, and process parameters for each process (assuming a process sequence) used to make the part, among others. Examples of quality KPIs or metrics include net promoter score (NPS), number of complaints per period, customer retention rate, average time to solve, cost of poor quality (COPQ), cost of high quality (COHQ), average rating score (ARS), defects per million (DPM), scrap rate, yield/efficiency, throughout, manufacturing cycle time, active defects, rejected defects, severe defects, among others.

The latent vectorial representation of each of the shape data and other data as embedded within the AI model can be concatenated into a unified latent vector to which automatic parts retrieval or data retrieval, e.g., based on a pairwise distance measure between a query part or data and all existing parts in the dataset of vectors, to provide closest matching parts or data. The exemplary system and method can improve the pre-processing of data and significantly improve part retrieval accuracy. The exemplary system and method can benefit manufacturing by allowing similarity search and design reuse. The exemplary system and method can also reduce the amount of time for pre-processing of data and/or improve part retrieval accuracy. The exemplary system and method can provide searching based on capabilities as defined by text or by part design as its associated design information.

A study was conducted to develop AI model enabled cyber manufacturing services that can connect end users with manufacturers over the internet to provide an automated part retrieval method that considers manufacturing process requirements, such as material properties, using deep unsupervised learning, among other described herein, that considers both part shape and material properties. Part retrieval results show that the unsupervised learning method yields 93.0% process and function class label matching precision, which outperforms the shape-only part retrieval model and supervised learning models trained with process, function, or both labels. While embodiments of the present disclosure are described for cyber manufacturing, it should be understood that other embodiments of the present disclosure can be used to perform any kind of part search or retrieval for any purpose.

In an aspect, a system is disclosed comprising: a processor; and a memory having instructions stored thereon, wherein execution of the instructions by the processor causes the processor to execute a part retrieval search by executing a set of processes to: receive a part model of a query part and material indication for the part; performing a shape and material similarity search, via a trained AI model (e.g., a 3D autoencoder), of the part model against a database of parts to identify a set of candidate models, wherein the trained machine learning operation was trained on both part shape and material properties and is configured to output a set of candidate part models and predictive value of likelihood a manufacturer associated with the set of candidate part models could manufacture the part model; and causing the set of candidate part models and the one or more predictive values of the likelihood the manufacturer to be able to manufacture the part model to be presented in a graphical user interface or to a report.

In some embodiments, the trained AI model was trained on material properties that include at least one of a material composition, a density parameter, a tensile strength parameter, and a melting point parameter.

In some embodiments, the trained AI model was trained on shapes that include a bearing, bushing, gear, collar, gear rack, screw, shaft, and key.

In some embodiments, the trained AI model was trained via a first encoding network associated with the part shape and a second encoding network associated with the material properties, wherein the first and second encoding networks are connected by a fully connected linear layer.

In some embodiments, the trained AI model was additionally trained on a part property (e.g., surface finish), wherein the shape and material similarity search includes a search of the property.

In some embodiments, the instructions further cause the processor to update the trained AI model by re-training the trained AI model with local data (e.g., by fine-turning the model weights and/or updating the model with the local data).

In some embodiments, the instructions further cause the processor to receive (i) an updated AI model or (ii) gradients and/or weights to update the trained AI model.

In some embodiments, the system is implemented in cloud infrastructure.

In some embodiments, the system is implemented as a remote server.

In some embodiments, the instructions further cause the processor to receive a database of parts over a web interface and retrain the trained AI model using the received database.

In another aspect, a non-transitory computer readable medium is disclosed having instructions stored thereon, wherein execution of the instructions by a processor causes the processor to execute a part retrieval search by executing a set of processes to: receive a part model of a query part and material indication for the part; performing a shape and material similarity search, via a trained AI model (e.g., a 3D autoencoder), of the part model against a database of parts to identify a set of candidate models, wherein the trained machine learning operation was trained on both part shape and material properties and is configured to output a set of candidate part models and predictive value of likelihood a manufacturer associated with the set of candidate part models could manufacture the part model; and causing the set of candidate part models and the one or more predictive values of the likelihood the manufacturer to be able to manufacture the part model to be presented in a graphical user interface or to a report.

In some embodiments, the trained AI model was trained on material properties that include at least one of a material composition, a density parameter, a tensile strength parameter, and a melting point parameter.

In some embodiments, the trained AI model was trained on shapes that include a bearing, bushing, gear, collar, gear rack, screw, shaft, and key.

In some embodiments, the trained AI model was trained via a first encoding network associated with the part shape and a second encoding network associated with the material properties, wherein the first and second encoding networks are connected by a fully connected linear layer.

In some embodiments, the trained AI model was additionally trained on a part property (e.g., surface finish), wherein the shape and material similarity search includes a search of the property.

In some embodiments, the instructions further cause the processor to update the trained AI model by re-training the trained AI model with local data.

In some embodiments, the instructions further cause the processor to receive (i) an updated AI model or (ii) gradients and/or weights to update the trained AI model.

In some embodiments, the system is implemented in cloud infrastructure.

In some embodiments, the system is implemented as a remote server.

In some embodiments, the instructions further cause the processor to receive a database of parts over a web interface and retrain the trained AI model using the received database.

In another aspect, a method is disclosed of training a machine learning operator, the method comprising providing an autoencoder; inputting a set of part shapes to a first encoding network of the autoencoder, the first encoding network being associated with part shape; and inputting a corresponding set of material properties to a second encoding network of the autoencoder, the second encoding network being associated with material properties, wherein the first and second encoding network are connected by a fully connected linear layer; and generating a classifier based on the autoencoder.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF DRAWINGS

FIGS. 1A and 1B each show an example searching system comprising a trained AI model configured on both part shape and material properties to allow for searching against a database of parts to identify, via an inquiry system 106, a set of candidate-like models or parts or supplier from an inquiry in accordance with an illustrative embodiment.

FIG. 2 shows an example of shape data and the material properties data that can be queried via the system of FIG. 1A or 1B.

FIG. 3 shows an example architecture of a trained AI Autoencoder model in a deep unsupervised learning-based part/supplier retrieval system based on the 3D autoencoder model in accordance with an illustrative embodiment.

FIG. 4 shows an example architecture of a trained AI Autoencoder model in a deep unsupervised learning-based part/supplier retrieval system based on the 3D autoencoder model in accordance with an illustrative embodiment.

FIGS. 5A and 5B each shows the federated and unfederated training workflow, respectively, and system of a deep unsupervised part retrieval model (e.g., FL-DUPR or DUPR) model in accordance with an illustrative embodiment.

FIGS. 6A and 6B show two algorithmic implementations of federated learning methods in accordance with an illustrative embodiment.

FIGS. 7A-7C as a set of corresponding figures, each show example sets of sequences of synchronous federated training workflow that can be applied to the system described in relation to FIGS. 5A, in accordance with an illustrative embodiment.

FIGS. 8A-8F, as a set of corresponding figures, show example sets of sequences of asynchronous federated training workflow that can be applied to the system described in relation to FIGS. 5A, in accordance with an illustrative embodiment.

FIGS. 9A-9B shows an example sequence of operations of the federated learning performed for a part or supplier in accordance with an illustrative embodiment.

FIGS. 10A-10D show a searching system and its associated performance, the system comprising a trained AI model configured on both part shape and material properties to query a part in accordance with an illustrative embodiment.

FIGS. 11A-11D show various features of a searching system and associated performance, the system comprising a trained AI model configured via federated learning on both part shape and material properties to query a supplier having a matched capability, in accordance with an illustrative embodiment.

### DETAILED DESCRIPTION

It is appreciated that certain features of the disclosure, which are, for clarity, described in the context of separate aspects, can also be provided in combination with a single aspect. Conversely, various features of the disclosure, which are, for brevity, described in the context of a single aspect, can also be provided separately or in any suitable sub-combination. Unless defined otherwise, all technical and scientific terms used herein have the same meaning as commonly understood by one of ordinary skill in the art. Methods and materials similar or equivalent to those described herein can be used in the practice or testing of the present disclosure.

### Example System

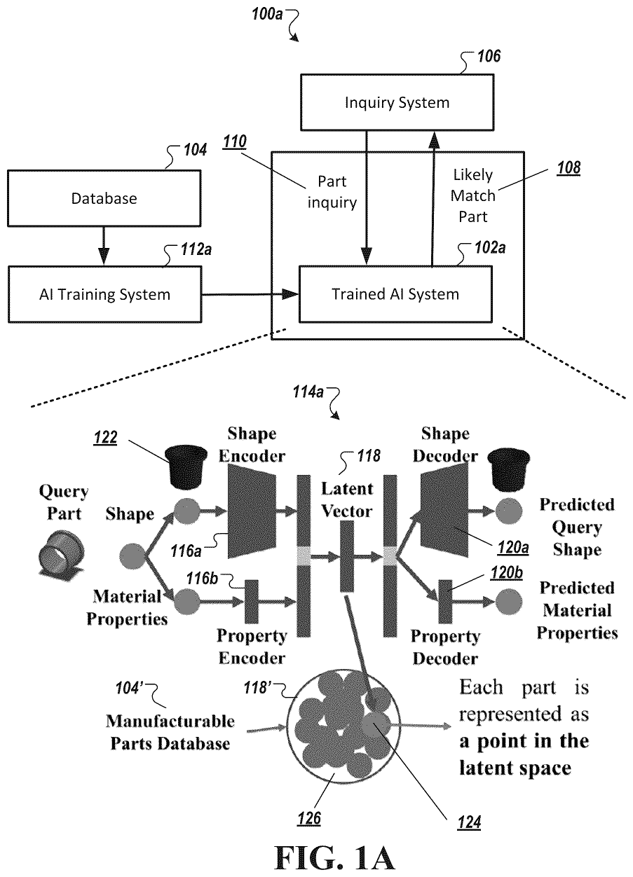

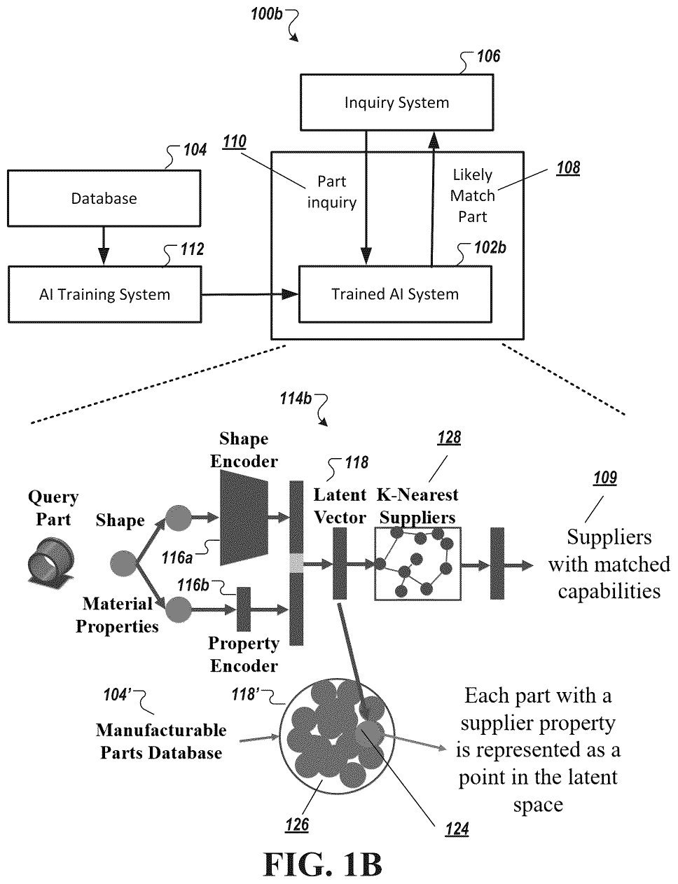

FIGS. 1A and 1B each show an example searching system 100 (shown as 100a, 100b) comprising a trained AI model 102 (shown as 102a, 102b) configured on both part shape and material properties to allow for searching against a database of parts 104 to identify, via an inquiry system 106, a set of candidate like models or parts 108 or suppliers 109 from an inquiry 110 in accordance with an illustrative embodiment.

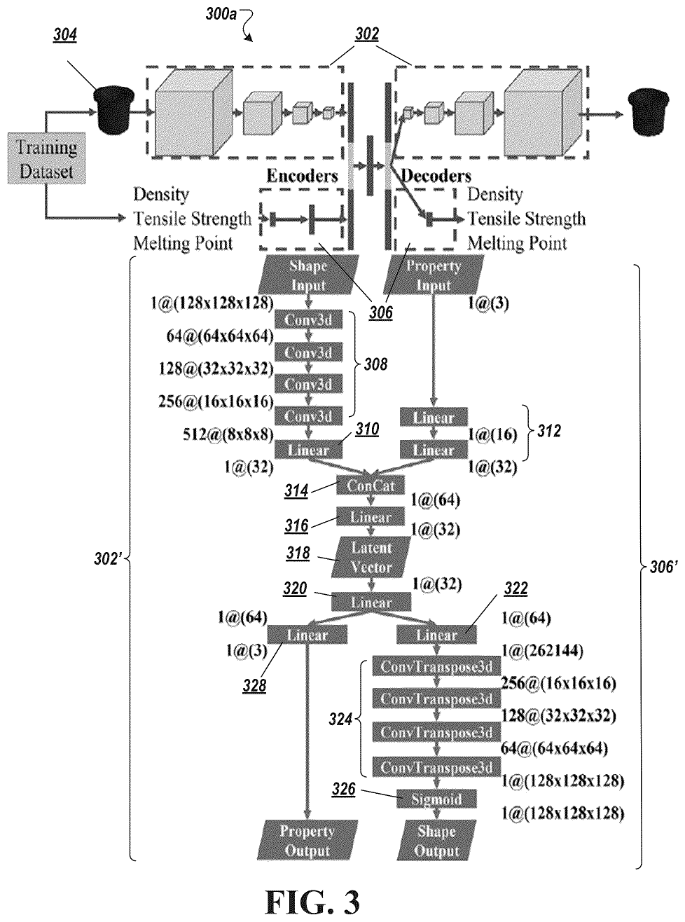

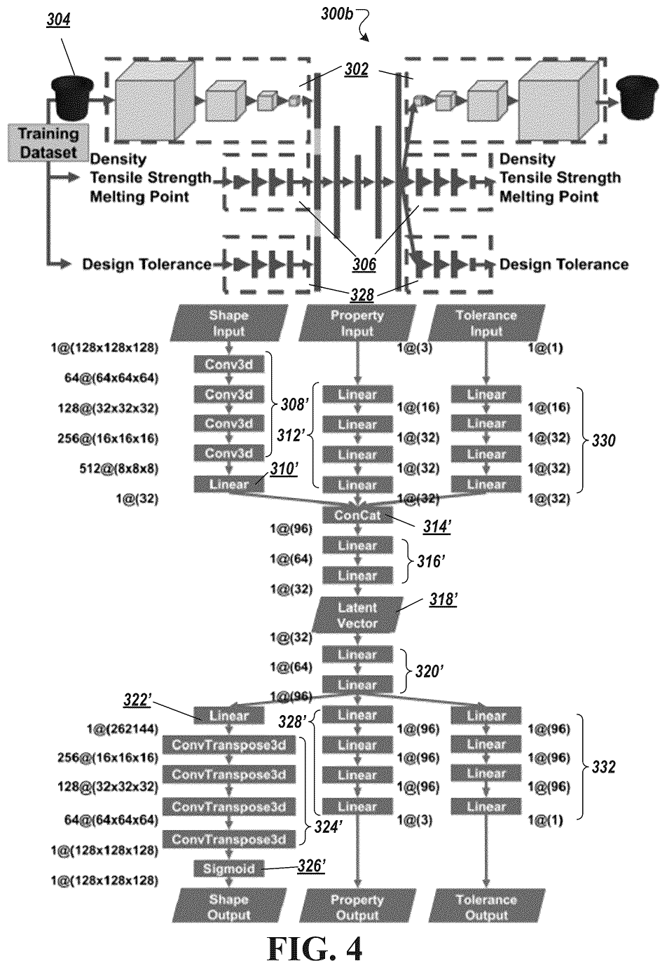

In the example shown in FIG. 1A, the trained AI model 102a is generated from an AI training system 112a that configures an autoencoder 114a having an encoder portion 116 (shown as “Shape Encoder” 116a, “Property Encoder” 116b) for each of the properties of interest, e.g., shape and material, that are coupled to a latent vector 118 and then a decoder portion 120 (shown as “Shape Decoder” 120a, “Property Decoder” 120b) for each of the properties. The latent vector 118 (shown as 118′) represents each part 122 of a manufacturable parts database (e.g., from database 104; shown as 104′) as a point 124 in a latent space 126. Other examples of trained AI system 102 are provided herein, e.g., shown in FIGS. 3 and 4. Notably, the trained AI system 102 includes two or more distinct encoding sections that are used to configure a common latent space/vector.

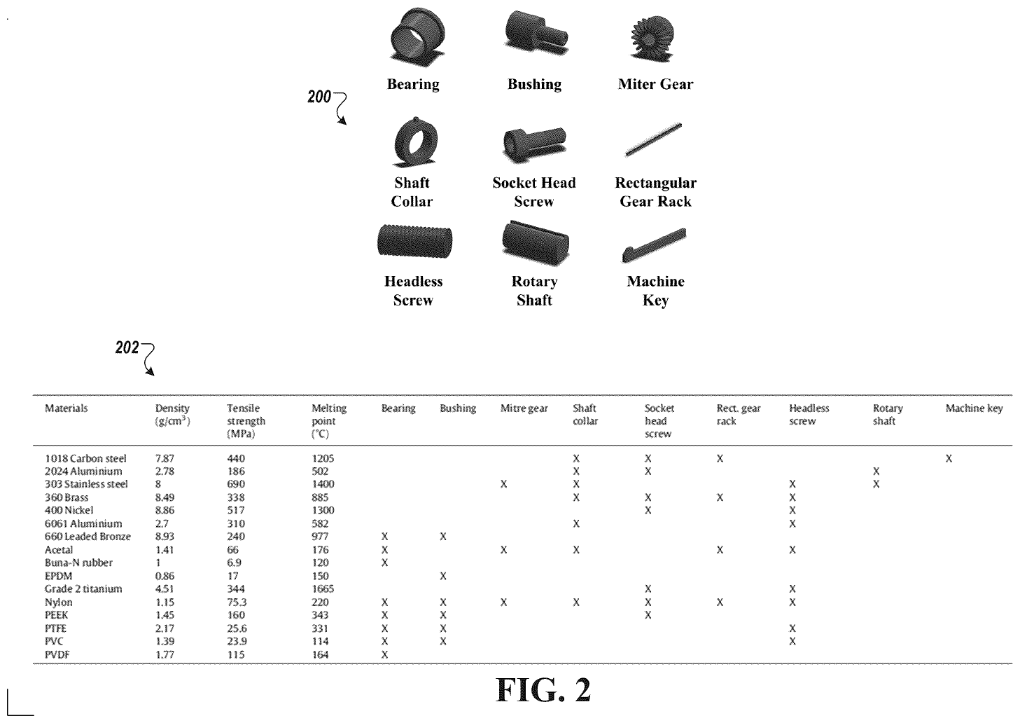

To develop the autoencoder 114a as a deep learning-based part retrieval model, the database 104 includes a dataset comprising 3D parts having (i) shape data comprising a geometry to describe its function (e.g., bearings, bushings) and manufacturing process class annotation (e.g., milling, injection molding), and (ii) material properties data comprising manufacturing capability information (e.g., material properties, among others) associated with shape data. FIG. 2 shows an example of the shape data and the material properties data that can be queried via the system of FIG. 1A or 1B. FIG. 2 additional shows other parameters that can trained to the latent and queries, e.g., surface finish and tolerance.

In the example shown in FIG. 1B, the trained AI model 102b is generated from an AI training system 112b that configures an autoencoder 114b having an encoder portion 116 (shown as “Shape Encoder” 116a, “Property Encoder” 116b) for each of the properties of interest, e.g., shape and material, that are coupled to a latent vector 118. A K-Nearest Neighborhood evaluation may be used to find the k-nearest suppliers 109 for a given part or queried property.

The system (e.g., 100a, 100b) of FIGS. 1A and 1B may be performed as a standalone server, private cloud infrastructure, or in multiple private and/or public cloud infrastructures (e.g., federated learning). The inquiry system 106 may be a part of the system (100a, 100b) or maybe a remote or separate computing device (e.g., associated with a user) that provides an interface for the submission of a query. In some embodiments, the inquiry system 106 may provide the interface for the transmission of the database (e.g., 104) to be used in the training.

### Example Training Operation.

In an example, a trained AI model was developed that can curate and process a subset of publicly available 3D parts data from the FabWave CAD repository [6], which was categorized into part function classes, as shown in FIG. 2. In total, 1354 parts consisting of 9 part function classes (200) per the table 202 in FIG. 2 were selected from the repository. Of those, 800 parts were randomly selected for training, while the remaining 554 parts were used for validation. A total of 45 distinct materials associated with the nine (9) function classes were collected. Of those, 16 selected material examples were employed, as shown in Table 202 of FIG. 2A with their respective function class associations. The materials were manually extracted from part catalogs. The corresponding material properties (density, ultimate tensile strength, and melting point) were obtained from MatWeb and used for training the deep learning part retrieval models. Each part in the function class was randomly assigned a material and its properties based on the associations indicated in Table 202 of FIG. 2.

Based on the function class and material properties, each part was assigned a manufacturing process label (e.g., turning, milling, injection molding). The process class label only indicates the process that creates the primary functional feature(s) of the part. To that end, while the parts can potentially be made using other processes, the training only provides a single label for each part as being made by either milling, turning, or injection molding. To improve training, e.g., by reducing complexity, manufacturing process labels were assigned in which (1) metal parts are not injection molded, and (2) the primary production process for axis-symmetric parts is turning. In the example embodiment, a voxel representation was used to train the deep learning-based part retrieval models. 3D CAD models were voxelized with a resolution of 128×128×128.

### Example Trained AI AutoEncoder Model

FIGS. 3 and 4 each show an example architecture 300 (shown as 300a, 300b) of a trained AI Autoencoder model in a deep unsupervised learning-based part/supplier retrieval system based on the 3D autoencoder model.

In FIG. 3, the model 300a includes (i) a shape encoder decoder pair (302) to encode geometric property information of a part 304 and (ii) a material property encoder-decoder pair (306) to encode material property information, e.g., shown in Table 202 of FIG. 2A. In FIG. 4, the model 300b includes (i) the shape encoder decoder pair (302) to encode geometric property information of a part 304, (ii) the material property encoder-decoder pair (306) to encode material property information, and additionally (iii) the tolerance input encoder-decoder pair (328) to encode tolerance property information, e.g., shown in Table 202 of FIG. 2A. Other material or manufacturing properties can be additionally encoded.

FIG. 3 shows an example architecture for the shape encoder decoder pair 302 (shown as 302′) and material property encoder-decoder pair 306 (shown as 306′). In the example, the shape encoder-decoder pair 302′ includes a plurality of convolutional 3D layers 308 that couples to linear layer 310, while the material property encoder-decoder pair 306 includes a plurality of linear layer 312. The two encoders are combined via a concatenation layer 314 followed by a linear layer 316, and then a latent vector layer 318 (previously referred to as 118) followed by a linear layer 320. The decoder portion of the shape encoder-decoder pair 302′ includes a linear layer 322 followed by a set of convolutional transpose 3D layers 324 and a sigmoid layer 326. The decoder portion of the material property encoder-decoder pair 306 includes a linear layer 328.

The objective function of the model of the deep unsupervised learning-based part retrieval system may include the shape reconstruction loss and the property prediction loss, per Equation 1.

$$L = {‖ \hat{x} - x ‖}_{2} + λ {‖ \hat{p} - p ‖}_{2} \qquad ( Eq . 1 )$$

In Equation 1, x is the input to the shape encoder, x is the output of the shape decoder, p is the input to the property encoder for manufacturability associated property, p is the output of the property decoder, and λ is a weight tuning parameter, which can be set to “1.” Both the encoders and decoders of both pairs (e.g., 302, 306) can be trained with a single same objective to minimize loss L.

In an example developed in the study, the models were constructed and trained using PyTorch, a Python-based deep learning library, on a high-performance computing node (PACE Phoenix Cluster with 1 NVIDIA Tesla V100 16 GB GPU). All components of the model of the deep unsupervised learning-based part retrieval system were trained simultaneously on the training dataset for 20 epochs. The batch size was set to 1 for training with Adaptive moment estimation (Adam) as the optimizer. The learning rates were set to 6×10⁻⁵.

FIG. 4 shows a model 300b that includes (i) the shape encoder decoder pair (302) to encode geometric property information of part 304, (ii) the material property encoder-decoder pair (306) to encode material property information, and additionally (iii) the tolerance input encoder-decoder pair (328) to encode tolerance property information, e.g., shown in Table 202 of FIG. 2A. The model 300b is configured to eliminate or reduce the deterministic pooling functions that allows the model to learn its own spatial down-sampling and up-sampling. Specifically, the encoder includes branches that encode the shape, material properties, and design (dimensional) tolerance, respectively, and the decoder branches predict the shape, material properties, and design tolerance.

In the example implemented in a study and quantified herein, model 300b was configured to operate on a voxelized model with voxels of size 128×128×128 to represent the shape of a given part. The selected material properties are the tensile strength, melting point, and density, which result in a material property vector size of 3×1. For the design tolerance, the scope is limited to the limiting tolerance, i.e., the minimum design tolerance for a given part, resulting in an input dimension of 1×1. In the example, the shape encoder branch has four 3D-convolutional (Conv3d) layers 308 (shown as 308′), and one linear layer 310 (shown as 310′). Each Conv3D layer includes a leaky rectified linear unit (LReLU) activation function with a negative slope of 0.2. The fully connected linear layer following the Conv3d layers produces an output with a dimension of 32×1.

As an extension of the model architecture described in [2′], the property encoder branch includes four linear layers 312 (shown as 312′) with a 32×1 output in the last layer. The same four-layer structure 312 (shown as 330) is used for the tolerance encoder branch, with an input dimension of size 1×1 and a 32×1 output. The outputs of the three encoder branches are concatenated into a single vector with a dimension of 96×1 via a concatenation layer 314 (shown as 314′), followed by two linear layers 316 (shown as 316′) that reduces the vector size to a latent vector having dimension 32×1. The decoder branches closely mirror their encoding counterparts and include two fully connected layers 320 (shown as 320′) that expand the dimension to 96×1, which is then used separately by the shape, property, and tolerance decoder branches. The shape decoder branch includes one linear layer 322 (shown as 322′) followed by four 3D-transpose-convolutional (ConvTranspose3d) layers 324 (shown as 324′) and a sigmoid layer to compress the value of each element within the 128×128×128 output to between 0 and 1. The property decoder branch uses four fully connected layers 328 (shown as 328′) to reduce the 96×1 vector to a 3×1 vector. The tolerance decoder branch utilizes a similar structure 328 (shown as 332) as the property decoder branch with the exception of the final output dimension, which is 1×1. The model 300b has enabled the integration of shape, material and design tolerance into a unified vector with the aim to balance the wide range of dimensionalities of manufacturing relevant multimodal inputs.

Other searchable parameters can be added in a similar way.

The objective function of each model 300b can be defined per Equation 2.

$$L = {‖ \hat{x} - x ‖}_{2} + {γ}_{1} {‖ \hat{p} - p ‖}_{2} + {γ}_{2} {‖ \hat{t} - t ‖}_{2} \qquad ( Eq . 2 )$$

In Equation 2, x is the input to the shape encoder, x is the output of the shape decoder, p is the input to the property encoder, \hat{p} is the output of the property decoder, t is the input to the tolerance encoder, \hat{t} is the output of the tolerance decoder, γ₁ and γ₂ are tuning factors. In the example, γ₁ and γ₂ were each set to 10. Both the encoder and the decoder were trained to minimize L. The models were constructed and trained using PyTorch, a deep-learning library for Python.

A description of a 3D autoencoder can be found in [8], which is incorporated by reference herein, though other modifications and architectures may be employed, e.g., as described in [9]. Other extensions of autoencoder can be employed, e.g., variational autoencoder (VAE) or transformer. Variational Autoencoder (VAE) is an extension of regular autoencoders, providing a probabilistic approach to describe an observation in latent space. A transformer can employ an encoder and a decoder, which can be used separately or in combination as an encoder-decoder model in which the encoder is an autoencoder (AE) model that encodes input sequences into latent representations and the decoder is an autoregressive (AR) model that generates output sequences based on the input representations.

### Example Federated Learning (FL) and Federated AI Model for Shape and Manufacture-Ability-Associated Searching

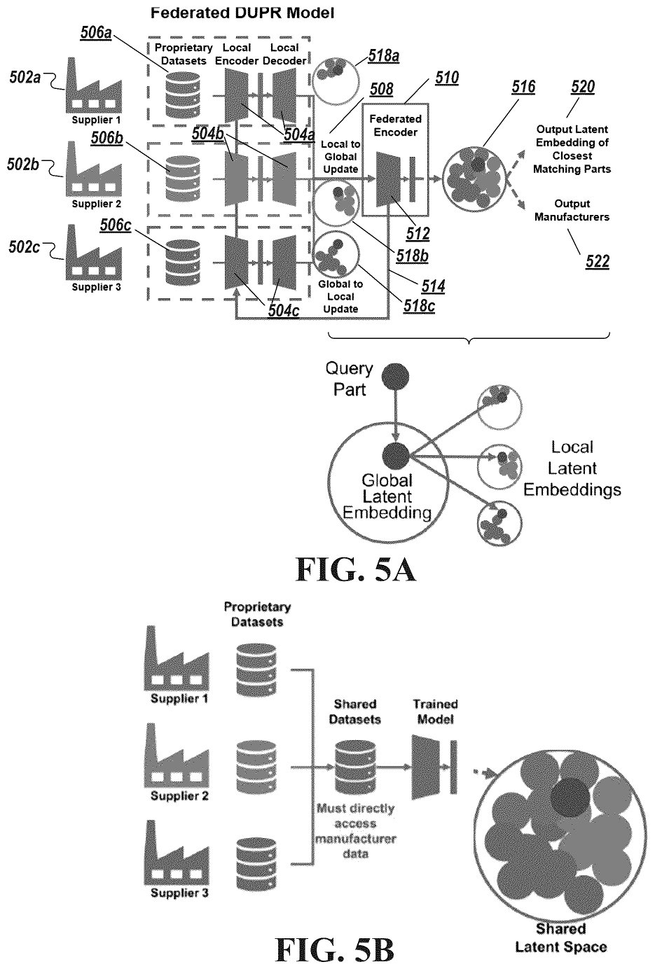

FIG. 5A shows an example similarity searching system 100 on both part shape and at least one manufacturability-associated data to search against a database of parts embedded within a trained federated AI model to identify, via an inquiry system, a set of candidate-like models or parts or capable manufacturer from an inquiry in accordance with an illustrative embodiment. FIG. 5B shows a centralized unfederated learning system in which data from the local suppliers are provided to a global server that performs training on the provided data. The system of FIGS. 5A and 5B each can be employed in the automated identification of suitable manufacturer or part from a query employed the exemplary trained AI model.

While FL by itself does not have provable guarantees for secure or private machine learning, it enables machine learning models to decentralize the training process to the client sites and enhances privacy by maintaining user data strictly on local client devices [19′].

FIG. 5A shows the federated training workflow and system of a deep unsupervised part retrieval model (FL-DUPR) model. In FIG. 5A (and FIG. 5B), each local supplier 502 (shown as “Supplier 1” 502a, “Supplier 2” 502b, and “Supplier 3” 502c) trains a local encoder and decoder 504 (shown as 504a, 504b, 504c) based on the local dataset 506 (shown as 506a, 506b, 506c). The local encoder and decoder 504 of each of the local supplier may have the same structure. Depending on the FL framework, the local gradients or weights of the local encoders are sent (508) to a server 510 and used to update the global federated encoder 512. In the training, the decoders are not learned globally to prevent direct inference using the decoder. After each update, the parameter weights of the global federated encoder 512 are sent back 514 to the suppliers 502a, 502b, 502c to update the local models 504a, 504b, 504c. Through iterative training, the federated encoder 512 indirectly captures a shared latent space 516 where all parts from local datasets (shown as 518a, 518b, 518c) can be embedded. The embeddings 516 can then be used to determine (520) the best matching part or determine (522) the supplier for a query part.

Using the latent embeddings of the parts (516), the query can evaluate a distance metric to determine whether a query part can be manufactured by a given supplier. As shown in FIG. 5A, this distance metric can be obtained automatically by evaluating the average distance between any data point and its kth nearest neighbor within the existing training dataset. Such a distance threshold can be obtained for each supplier.

In FIG. 5A, whether a query part can be manufactured by the given supplier is then evaluated by comparing its distance in latent embedding 516 to the kth nearest neighbor in the training dataset. If the distance is less than the threshold, the query part is deemed to be manufacturable by the supplier to provide output 520. The evaluation can be conducted locally at the supplier level so the local training data are not shared outside the supplier.

In FIG. 5A, whether a manufacturer can be manufactured by a given supplier is evaluated by comparing its distance in latent embedding 516 (shown as 516′) to the kth nearest neighbor in the training dataset. If the distance is less than the threshold, the manufacturer is deemed to be manufacturable by the supplier to provide output 522. The evaluation can be conducted locally at the supplier level so the local training data are not shared outside the supplier.

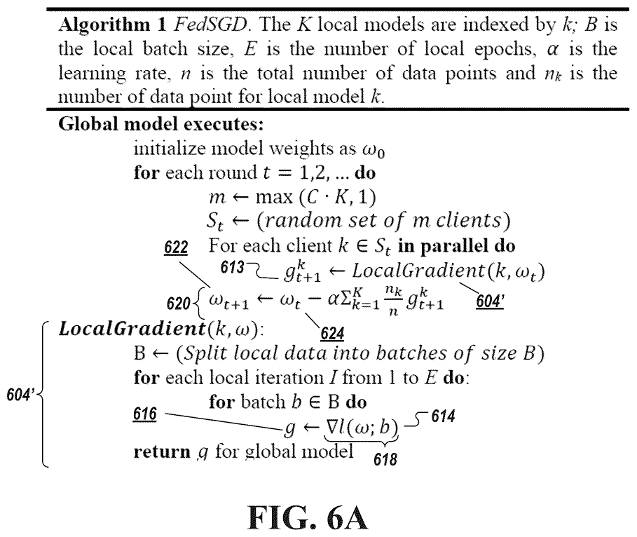

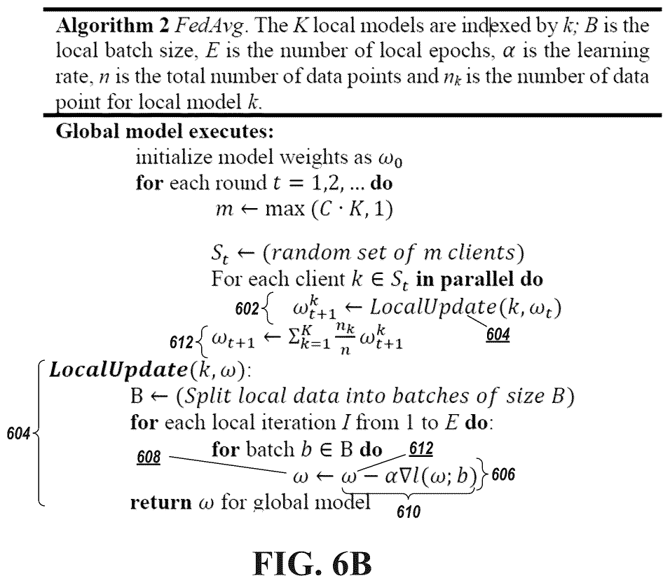

Federated Stochastic Gradient Descent and Federated Averaging. In FIG. 5A, it is envisioned that manufacturing capability models can be transformed into FL-based manufacturing capability models by implementing data boundaries to strictly update the global model based on local models rather than directly train a global model on local data. FIGS. 6A and 6B show algorithmic implementations of FL methods [4′], including federated stochastic gradient descent (FedSGD) and federated averaging (FedAvg), for cyber manufacturing as-a-service.

FedSGD computes the gradients locally and sends the gradients to the global model for updates, after which the global model parameters are sent back to the local models. FedAvg requires local models to update locally using local gradients via gradient descent first and then sends the updated parameter weights of the local models to the server, after which the global model is updated with average weights. FIG. 6A (shown as “Algorithm 1”) shows the pseudocode for FedSGD, and FIG. 6B (shown as “Algorithm 2” shows the pseudocode for FedAvg. The differences occur in both global model execution and local gradient computation in these algorithms.

While Algorithms “1” and “2” are similar in providing global and local updates and communication to achieve indirect training of global models, FedAvg can be more efficient than FedSGD in both communication and computation [4′] while FedSGD can guarantee that training of the global model eventually converges to a non-FL model, as the local models simply send gradients to the global model for updates similar to how minibatch gradients are aggregated in conventional deep learning. A simple optimizer with a deterministic learning rate for stochastic gradient descent (SGD) can be used across all models. The inputs may be multimodal inputs (shape, material properties, and quality attributes). In some embodiments, an adaptive moment estimation (Adam) for its adaptive learning rates [20′] can be used to improve model training performance in complex learning tasks. To utilize Adam, the optimizer states may be shared that specify the current adaptive learning rates, the first moments of the learning rates, and the second moments of the learning rates for all model parameters across all local models, which adds to the communication cost.

Federated Averaging Learning. In the example shown in FIG. 6B (FedAvg), as compared to FIG. 6A, the global model 512 performs (602) for each client k a LocalUpdate operator (604) that updates the weights ωₜ₊₁^{k} for the next iteration t+1 of the model based on the current weights ωₜ per Equation 3 where for each iteration of that client k, the operator LocalUpdate (604) performed locally at the client 502 updates (606) its weight ω (608) as a gradient via ω-α∇l(ω; b) (610) according to Equation 2. The learning is performed by the client 502, and the weights ω for each client is transmitted to the global model 512. Per Equation 4, the weights ω (608) is updated (616) by current weights ω (612) subtracted by the learning rate α applied to gradient ∇ having loss function l (per Equations 1 or 2) for a given w and batch b to provide average the federated learning for each of the client.

$${ω}_{t + 1}^{k} ← LocalUpdate ( k , {ω}_{t} ) \qquad ( Eq . 3 )$$

$$ω ← ω - a ∇ l ( ω ; b ) \qquad ( Eq . 4 )$$

As noted in FIG. 6B, w is the current weights, a is the learning rate, b is a batch index for the local batch size B.

The global model 512 then determines (612) the next iteration of the weights ωₜ₊₁ as a summation for each of the client k to K, of the next weight ωₜ₊₁^{k} as returned by the LocalUpdate scaled by the number of data points nₖ/n. for the model k normalized by a total number of data points n per Equation 5.

$${ω}_{t + 1} ← {\sum }_{k = i}^{K} \frac{{n}_{k}}{n} {ω}_{t + 1}^{k} \qquad ( Eq . 5 )$$

As noted in FIG. 6B, K is the local model indexed by k; B is the local batch size, n is the total number of data points, and nₖ is the number of data points for the local model k.

Federated Stochastic Gradient Descent Learning. In contrast, in FIG. 6A (FedSGD), the global model 512 (FIG. 5A) performs (613) for each client k data a LocalUpdate (shown as 604′) that update the global weights gₜ₊₁^{k} for the next iteration, t+1 of the model based on the current weights ωₜ where for each iteration of that client k, the operator LocalUpdate (604′) is performed at the local client to compute (614) its gradient g 616) via ∇l(ω; b) (618) as g←∇l(ω; b) per Equation 6. The global model 512 then determines (620) the next iteration of the weights ωₜ₊₁ (622) as the current weight ω (624) subtracted by the learning rate α applied to a summation for each of the client k=1 to K, of the next weight gₜ₊₁^{k} as returned by the LocalGradient scaled by the number of data points nₖ/n. for the model k normalized by a total number of data points n per Equation 7.

$$g ← a ∇ l ( ω ; b ) \qquad ( Eq . 6 )$$

$${ω}_{t + 1} ← {ω}_{t} - α {\sum }_{k = 1}^{K} \frac{{n}_{k}}{n} {g}_{t + 1}^{k} \qquad ( Eq . 7 )$$

Indeed, the federated stochastic gradient descent learning per FIGS. 5A and 6A and federated average learning per FIGS. 5A and 6B can be employed to provide query-able latent embeddings to identify best matching parts (516, 516′) and matching manufacturers (522, 522′) for a given part.

### Example Federated Learning Operation

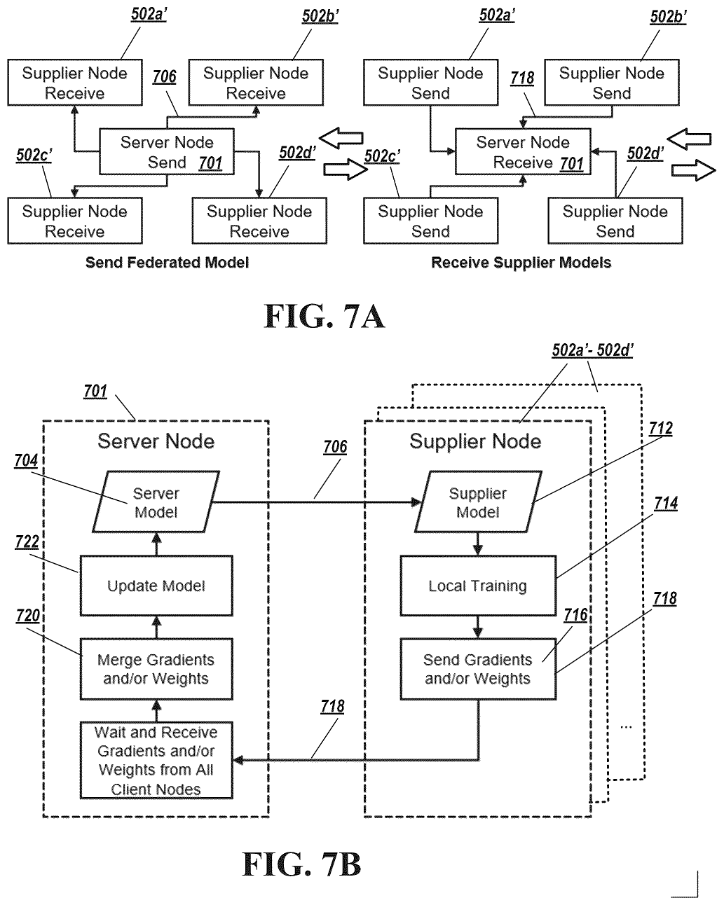

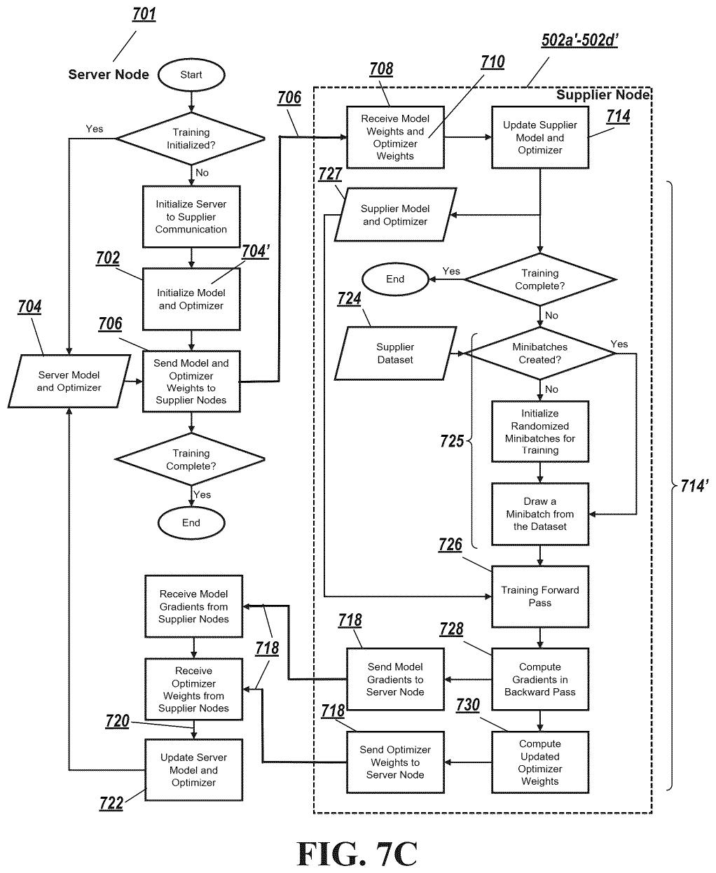

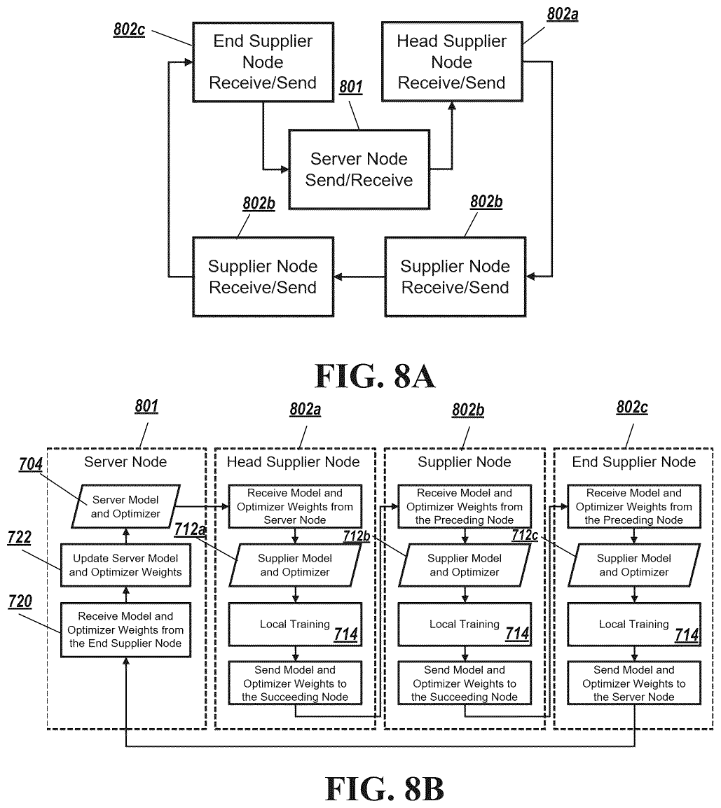

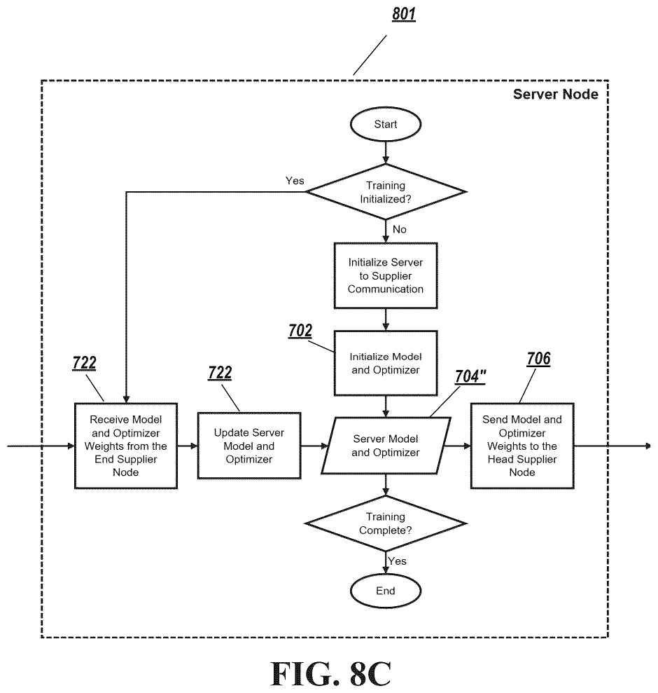

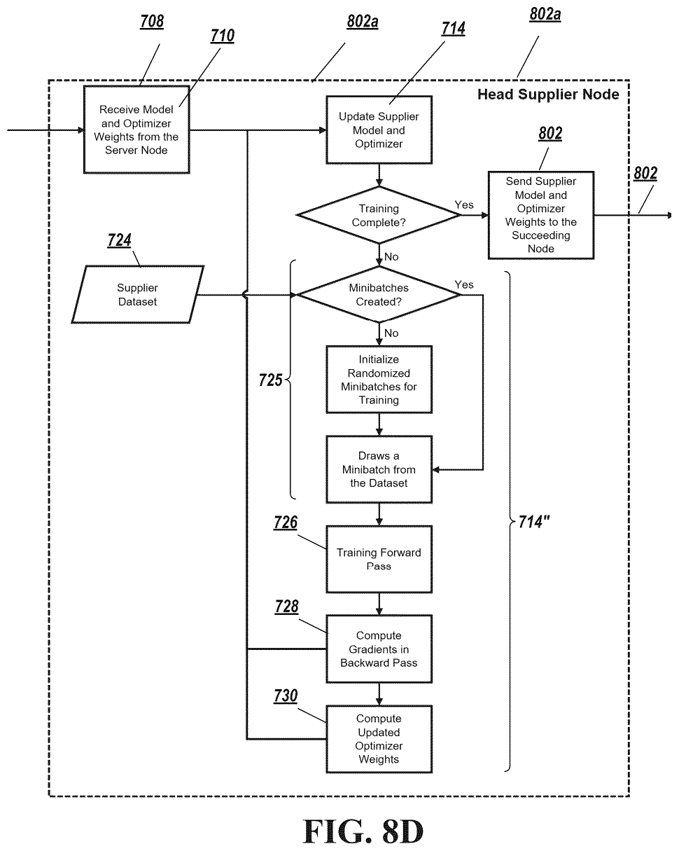

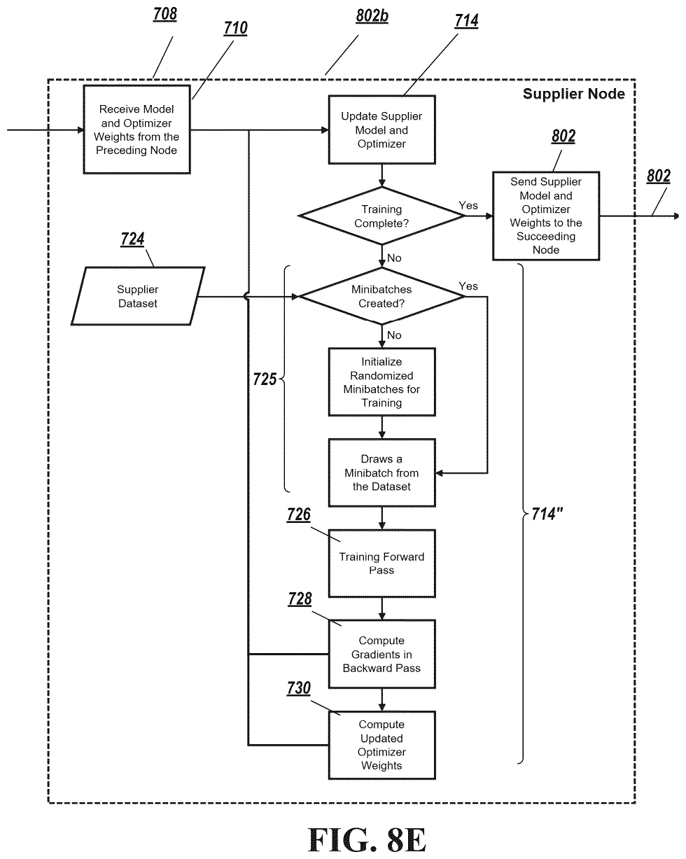

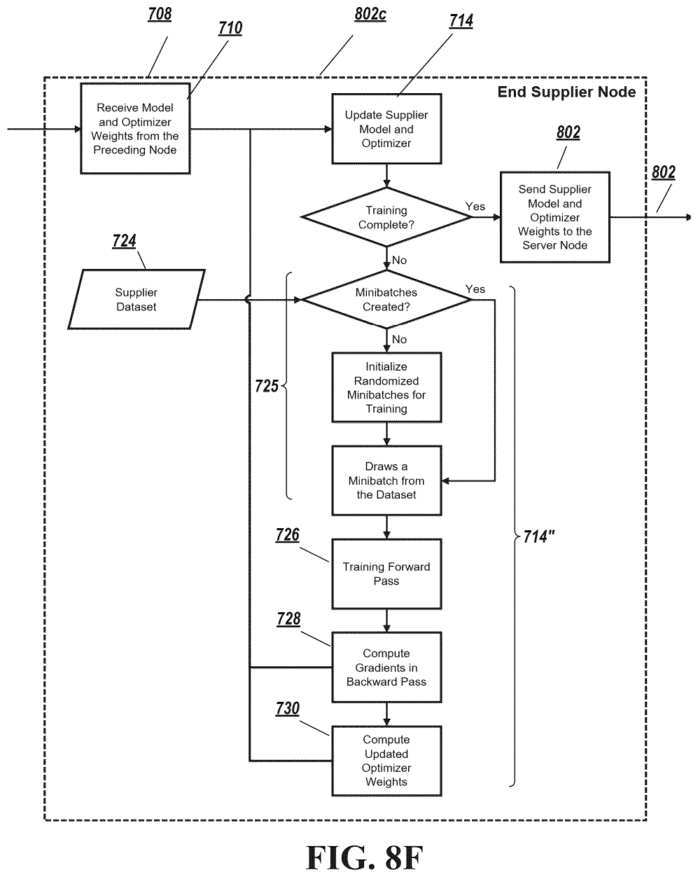

FIGS. 7A-7C and 8A-8F, as a set of corresponding figures, each show example sets of sequences of the federated training workflow that can be applied to the system described in relation to FIG. 5A. In FIG. 7A-7C, the federated stochastic gradient descent learning or the federated averaging learning, e.g., of FIG. 5A, among other federated learning methodologies, can be performed in a synchronous manner between a global model (e.g., 512) and the client nodes (e.g., 502). In FIGS. 8A-8F, the federated stochastic gradient descent learning or the federated averaging learning of FIG. 5A, among other federated learning methodologies, can be performed in an asynchronous manner, e.g., between a global model (e.g., 512) and the client nodes (e.g., 502), e.g., for the learning described in relation to FIG. 5A.

Example Synchronous Operation. In the example shown in FIGS. 7A-7C (which shows among each other the same or different processes), the global server (e.g., 512; now shown as 701) initializes (702) an initial global model (shown as “server model” 704′) that is then sent (706) to each supplier node 502 (shown as 502a′-502d′). Each supplier node 502a′-502d′ receives (708) the global model comprising weights and optimizer weights (710) and characterizes the received model as a supplier model 712. Each supplier node 502a′-502d′ then performs local training (714, also shown as 714′) to update the supplier model and optimizer. The model weights and optimizer weights of each of the supplier models 716 are then sent (718) back to the global server 701 to merge (720) the received model weights and optimizer weights of each of the supplier models and update (722) the global model (704).

In the example shown in FIG. 7C, the local training 714′ at each node 502a′-502d′ includes using the local supplier dataset 724 in batches, after some initialization of the batching (725), to perform a training forward pass operation 726 (e.g., per FIG. 6A) with the existing supplier model and optimizer weights (727), compute (728) the gradient in the backward pass (e.g., per FIG. 6A), and compute (730) the updated optimizer weights.

As noted, the operation of FIG. 7A-7C can be performed for the federated learning of FIG. 5A using the algorithms of FIGS. 6A, 6B, among others.

Example Asynchronous Operation. FIGS. 8A-8F shows an example federated learning in an asynchronous manner, e.g., between a global model (e.g., 512, now shown as 801) and the client nodes (e.g., 502, now shown as 802), e.g., for the learning described in relation to FIG. 5A.

In the example shown in FIGS. 8A-8C (which shows among each other different levels of information for a same or different process), the global server (e.g., 801) initializes (702) an initial global model (shown as “server model” 704″) that is then sent (706) to a first supplier node 802a (shown as “Head Supplier Node” 802a) that performs local training (714) to update one or more next supplier node 802b (shown as “Supplier Node” 802b) up to a last supplier node 802c (shown as “End Supplier Node” 802c) that then transmit the updated model parameters (e.g., weights) back to the server model 801. Each supplier node 802b and end supplier node 802c similarly perform local training 714 to this model 712b, 712c.

In FIGS. 8D, 8E, and 8F, the supplier node (e.g., first supplier node 802a, supplier node 802b, and end supplier node 802c) receives (708) a model (e.g., a global model in the case of FIG. 8C, or supplier model in the case of FIG. 8D) comprising weights and optimizer weights (710) and characterize the received model as a supplier model (712a). In FIG. 8D, the first supplier node 802a receives an initialized global model from the global server 801. In FIG. 8E, the supplier node 802b receives (after the first supplier node is done with its local training) a local model from the first supplier node 802a. In FIG. 8F, the end supplier node 802c receives (after the prior supplier node is done with its local training) a local model from a prior supplier node 802b.

Each supplier node (e.g., first supplier node 802a, supplier nodes 802b, and end supplier node 802c) then performs local training (714, also shown as 714″) to update the supplier model and optimizer (e.g., 712a, 712b, 712c, respectively). The model weights and optimizer weights (716) of the supplier model are then sent (802) to the next supplier node (e.g., supplier node 802b or end supplier node 802c). In the case of the end of the end supplier node, the model weights and optimizer weights (716) of the supplier model are then sent (804) to the global server 801 to merge (720) the received model weights and optimizer weights of the end supplier model to update (722) the global model (704).

In the example shown in FIGS. 8C and 8D, the local training 714′ at each node 502a′-502d′ includes using the local supplier dataset 724 in batches, after some initialization of the batching (725), to perform a training forward pass operation 726 (e.g., per FIG. 6A) with the existing supplier model and optimizer weights (727), compute (728) the gradient in the backward pass (e.g., per FIG. 6A), and compute (730) the updated optimizer weights.

As noted, the operation of FIG. 8A-8F can be performed for the federated learning of FIG. 5A using the algorithms of FIGS. 6A, 6B, among others.

### Example Query of a Federated Learned System for Matching Supplier

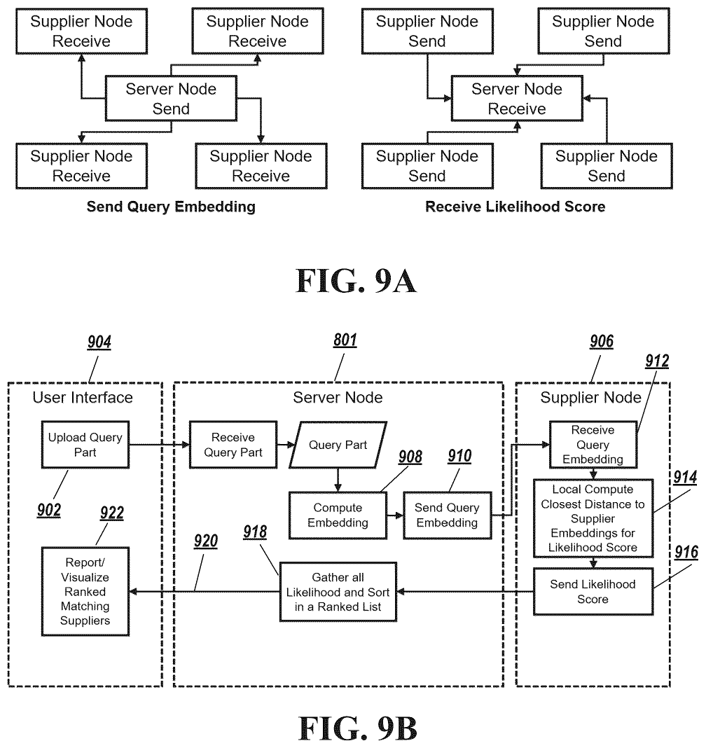

FIGS. 9A-9B shows an example sequence of operation of the federated learning performed in a query (e.g., for a part or supplier). In FIGS. 9A and 9B, a query part (902) from a computer device 904 is provided to a server node (512, also shown as 801). The server node 801 computes (908) an embedding and sends (910) a query embedding to supplier nodes 502. The supplier nodes 502 receives (912) the query embedding and computes (914) a closed distance value for that supplier as a likelihood score. Each supplier 502 then sends (916) its likelihood score to the server node (906) that aggregates (918) the likelihood score to provide (920) a ranked list of matching suppliers to the requested computing device 904 (shown as “report/visualize” 922).

### EXPERIMENTAL RESULTS AND ADDITIONAL EXAMPLES

### Part Learning Study

A first study was conducted to develop and evaluate a shape-based and material-property-based autoencoder model (referred to as the exemplary DUPR model). The study constructed a shape-only autoencoder model for comparison. The architecture of the shape-only autoencoder follows exactly the shape encoder-decoder pair of the exemplary DUPR model. The difference between the two models was the exclusion of material properties in the shape-only autoencoder model. The model was trained on the same dataset for 20 epochs. The loss function (e.g., Equation 1) was modified to exclude material property loss (second term). In addition, the study also evaluated the performance of directly concatenating material properties to the latent shape vector as an alternative strategy to combine both types of information.

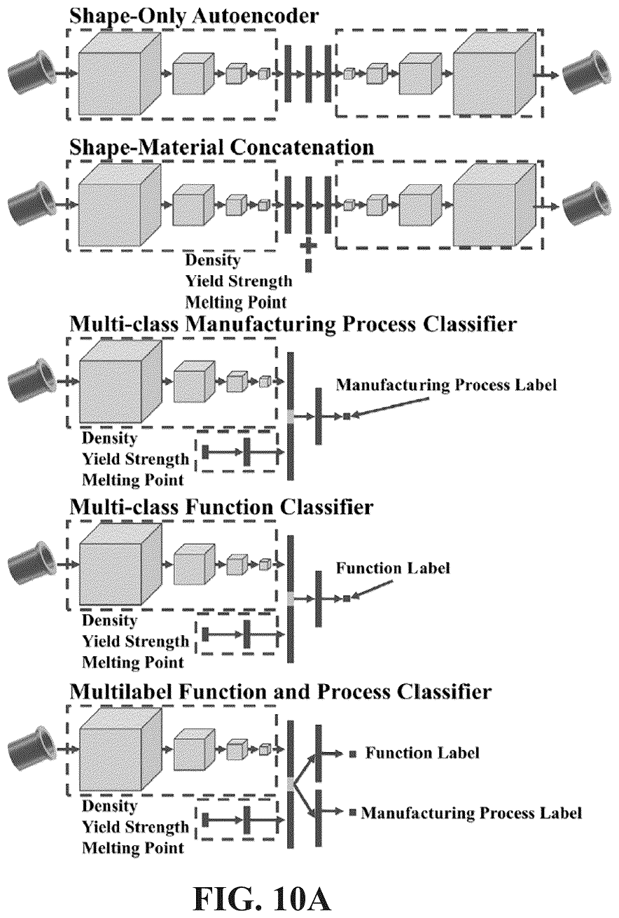

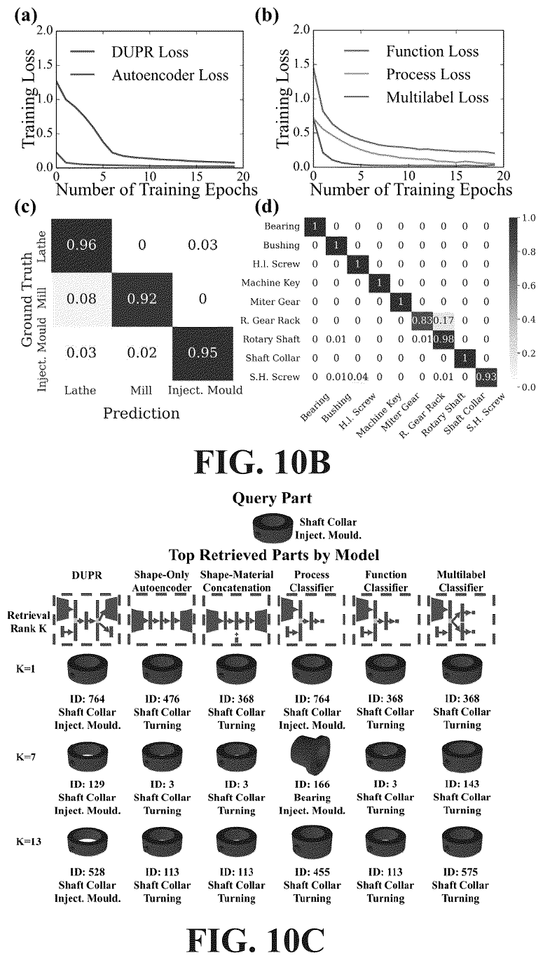

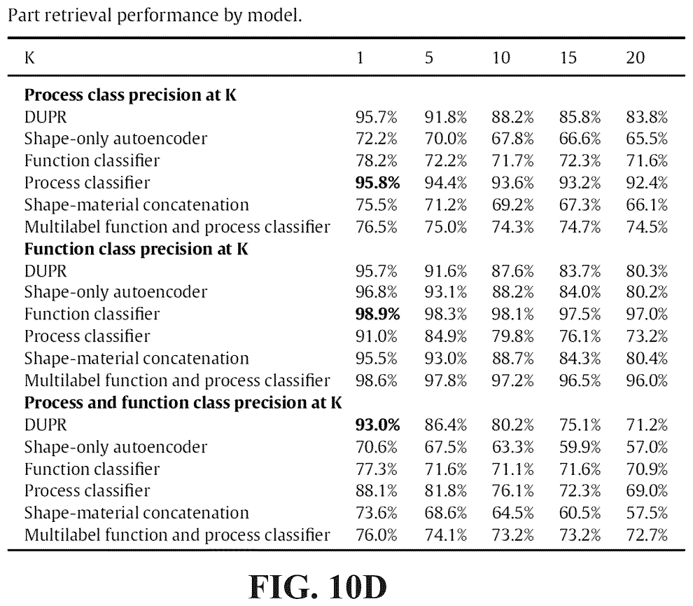

To determine the most effective method to embed material property information with shape information, the study trained a manufacturing process classifier and a function classifier using the supervised deep-learning models shown in FIG. 10A. In addition, a multilabel model was trained with respect to both function and process labels. FIG. 10A shows the models built in the study for comparison.

Supervised learning-based classifiers have been shown to effectively retrieve parts with manufacturing metadata (e.g., dimensions) [6]. The architecture of the supervised learning-based classifiers follows that of the shape and material property encoders in the exemplary DUPR model. However, instead of a full decoding network, a single fully connected linear layer is applied to the encoding networks, which reduces the vectorial representation to the number of classes (3×1 for the process classifier and 9×1 for the function classifier). A SoftMax layer follows the linear layer to assign a probability to each class. All three classifier models were trained on the same training dataset for 20 epochs using a batch size of 1 with the cross-entropy loss as the objective function. For the multilabel classifier, the combined loss function is the sum of function label cross-entropy loss and process label cross-entropy loss.

FIG. 10B shows the results of the unsupervised, and supervised learning models which were evaluated by observing the training losses. Specifically, FIG. 10B, subpanel A shows training losses of the exemplary DUPR model vs. shape-only autoencoder, subpanel B shows training losses of function classifier vs. manufacturing process classifier vs. multilabel classifier, subpanel C shows validation confusion matrix of manufacturing process classifier, and subpanel D shows validation confusion matrix of function classifier.

In addition, the study evaluated the supervised learning models using the classification accuracy on the validation dataset, which consisted of 554 unseen test parts. From FIG. 10B, it can be observed that all models converged to a low loss at 20 epochs. The exemplary DUPR model had a higher loss compared to the shape-only autoencoder, which can be attributed to the inclusion of material properties in the loss function. The process classifier converged slower than the function classifier, which is due to differences in classification objectives. It can be observed that both the function classifier and the process classifier reached a high level of validation accuracy, as seen in FIG. 10B, subpanels (c) and (d). The average class validation accuracy of the process classifier was 94.6%, and the average class validation accuracy for the function classifier was 97.2%. The results indicated that the models are well-trained for the part retrieval experiment.

FIG. 10C shows an example part retrieval workflow and results. The study constructed six models that differed in their training objectives (i.e., shape and material vs. shape-only, supervised vs. unsupervised learning). In the study, each part has 32×1 latent vectors derived from each trained model, with the exception of shape-material concatenation, which outputs 35×1 latent vector by directly concatenating the material properties. All parts in the manufacturing parts database are embedded as latent vectors using each of the six models. In FIG. 10C, the query part input to the models was converted to a latent vector from which pairwise similarities between the latent vector of the query part and all latent vectors in the manufacturable parts database are computed. The vectorial cosine distance is used as the similarity metric to retrieve the closest matching parts.

To evaluate the performance of the part retrieval models, the study compared the function and process class labels of the retrieved parts with those of the query part. Precision at K was used as the performance metric that computed the ratio between the number of relevant items to the total number of retrieved items, K[6]. For each of the 554 test query parts, the study retrieved the top 20 best-matching parts from the training dataset. FIG. 10D shows a summary of the part retrieval performance based on the precision at K of the process class label, function class label, and combined process and function class labels.

From FIG. 10D, it can be observed that the exemplary DUPR model outperformed the shape-only autoencoder model in terms of both process and function class label precision at 1 (93.0%). The shape-only autoencoder performed slightly better than the exemplary DUPR model in only function label precision at 1 (96.8%). However, the much worse performance of the shape-only autoencoder in process class label precision at 1 (72.2%) and the combined process and function class labels precision at 1 (70.6%) indicated that shape alone is insufficient for part retrieval in the context of cyber manufacturing search, where process class matching was likely essential to identify a suitable manufacturer with the necessary capabilities.

The supervised learning models resulted in high precision of process or function class label at the cost of induced bias. For example, the part function classifier reached 98.9% precision at 1, but only 78.2% of the retrieved parts satisfied the process class label matching requirement. Such bias toward the training objective was also observed in parts retrieved by the process classifier. The DUPR model performed well at 95.7% for process class precision at 1, which indicated that shape and material similarities are significant factors in determining process similarity. When considering the combined class labels' precision, the exemplary DUPR model performed the best, surpassing all supervised models. The process and function labels were only available for the experiment presented here. The availability of class labels was a prerequisite for supervised learning. In practice, however, it can be laborious and challenging to label parts based on process or function. It was observed that a change in the training objective from process to function can alter the part retrieval results significantly, which highlights the need for unsupervised learning methods that reduce the impact of training bias.

The study included a deep unsupervised learning-based part retrieval (DUPR) model, which considers both the shape and material properties of query parts as inputs to retrieve the closest matching parts from a previously manufactured parts database. Through a comparative parts retrieval experiment, it was shown that (1) including manufacturing capability information (e.g., material properties) in the part retrieval model significantly improves the retrieval precision when both part function and process class labels are considered, and (2) the proposed DUPR model reduces bias in training and outperforms the supervised learning models yielding a combined process and function class precision at 1 of 93.0%. Optionally, other manufacturing capabilities information, such as part quality and production quantity, can be considered as embodiments of the present disclosure. In addition, most data presented in the experiment are axisymmetric. While the presented method is also applicable to prismatic parts, additional pre-processing, such as part orientation alignment and fixture placement, can be used in some embodiments of the present disclosure. The example embodiment can be applied to rapidly and automatically quote manufacturing services, e.g., by rapidly and automatically determining what will be required to manufacture the part. Optionally, this can be performed by including pricing data in the method described herein.

### Supplier Learning Study

A second study was conducted to develop and evaluate an FL-DUPR model for part selection and supplier selection. The study also employed a classic deep learning-based classification model trained using the federated learning framework (FL-3DCNN) as a baseline model for comparison to the FL-DUPR model. A 3D CNN is a deep learning model that takes voxel objects as input to enable various deep learning tasks [24′]. In manufacturing, deep learning methods based on 3D CNN have been used for machining feature recognition [14′], manufacturing process classification [17′], and part retrieval [2′]. The study used federated learning frameworks to enable federated learning-based 3D CNN (FL-3DCNN).

The federated-learning-based embedding model (FL-DUPR) can enable supplier selection, which indirectly accesses shape, material properties, and design tolerance to select potential suppliers. Through two comparative supplier selection case studies, the second study showed that (1) gradient sharing in FL recapitulates the non-FL model better than weight sharing while avoiding direct access to proprietary datasets of the suppliers, and (2) the exemplary FL-DUPR model performed comparably to the baseline FL-3DCNN model in case study #1 with no overlap in manufacturing capability, reaching a supplier selection accuracy of 89%, while outperforming the FL-3DCNN model in case study #2 where manufacturing capabilities overlap with a supplier selection accuracy of 87.8%.

Since complicated manufacturing-related prediction tasks often contain ambiguity and clear-cut labels are hard to obtain, the foregoing results showed that embedding models can perform better than discriminative models in predicting multiple viable options. The prototype provided the integration of federated learning frameworks with manufacturing-focused embedding and classification models in the context of cyber manufacturing as-a-service, which can improve data access control and enable effective ranking of manufacturing capabilities across the suppliers for a part design. The methods can benefit cyber manufacturing as-a-service platforms to enable manufacturing capability-driven pricing strategy, which in turn can result in wider industrial adoption of platform-based manufacturing.

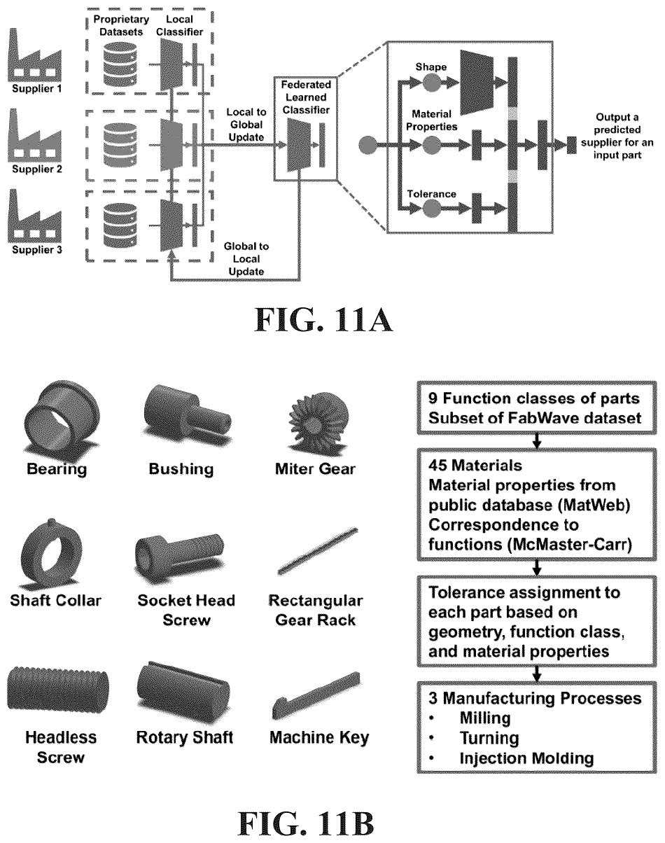

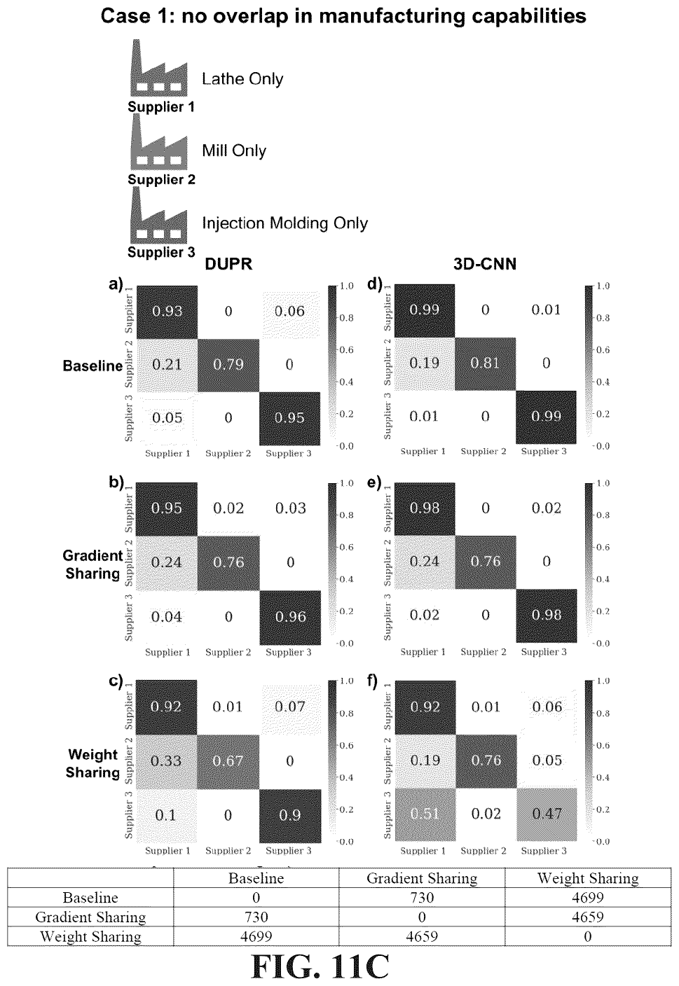

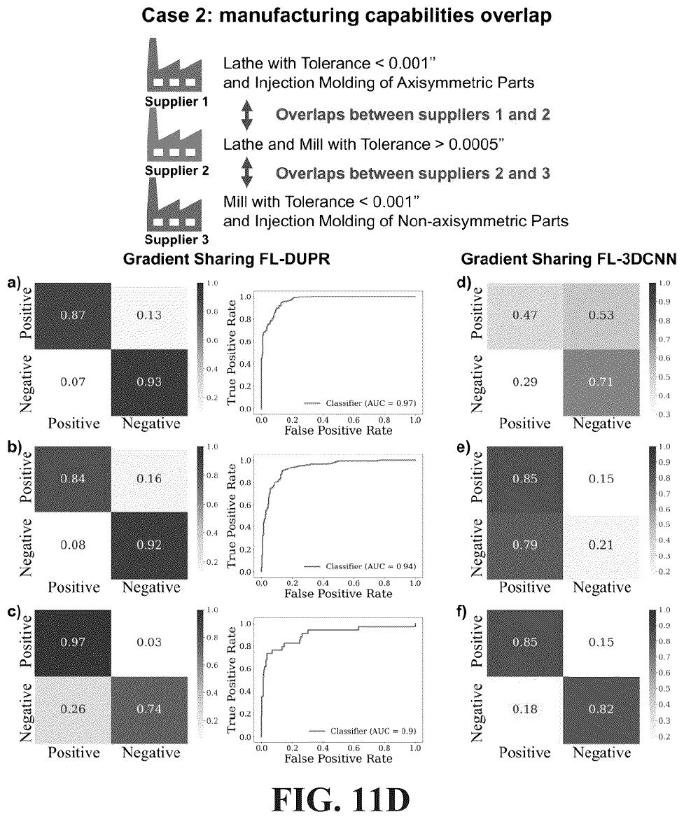

FIG. 11A shows the training workflow of the baseline FL-3DCNN model. Each local supplier trained a local classifier based on their proprietary dataset. The classifier was trained in a supervised fashion using supplier labels, which, for a given supplier, the labels are deterministic one-hot encoded vectors. Similar to training the FL-DUPR model, the local gradients or weights of the local classifiers of the FL-3DCNN were sent to a server and used to update the global federated classifier. The parameter weights of the global federated classifier were sent back to the suppliers to update the local classifier after each training batch. After iterative training, the global federated classifier should have learned to discriminate between the different suppliers based on part shape, material properties, and design tolerance and predict a supplier label for each query part. The architecture of the local classifiers in the FL-3DCNN model followed that of the encoding branch shown in FIG. 3B. The study assumed that the total number of suppliers in the network is known, and the supplier labels in the form of one-hot encoded vectors can, therefore, be obtained implicitly (in implementation, the system can register and established access with each supplier to have a list of supplier nodes for the training and query). A single fully connected linear layer was applied at the end to reduce the latent vector to the number of suppliers. A SoftMax layer was applied after the linear layer to assign each supplier a probability of matching their manufacturing capability to the requirements of the input design. The objective function of the local models in FL-3DCNN was defined per Equation 8.

$$L = - {\sum }_{j}^{c} {y}_{j} log {\hat{y}}_{j} \qquad ( Eq . 8 )$$

In Equation 8, C is the number of suppliers, γⱼ is the correct supplier label for class j, and \hat{γ}ⱼ is the predicted probability for supplier j. By computing the losses, the gradients can be computed locally for all parameters by backpropagation, which can be used to update global models via FedAvg or FedSGD, as described in relation to FIGS. 6A and 6B (as well as FIG. 5A). The objective function for the FL-3DCNN was inherently different from that of the FL-DUPR model, even though the two models perform the same task. Conventionally, discriminative models, e.g., of FL-3DCNN, aim to learn the classification boundaries directly to select a class for a given input, i.e., a supplier for a query part. In contrast, the embedding models, such as FL-DUPR, aim to learn a compressed representation of the parts and selected suppliers based on whether a supplier has made a similar part to the query part, as described in relation to FIGS. 3, 4, and 5A. As a result, the different objective functions produced different supplier selection performances.

### Case Studies—Supplier Selection

Data Preparation. To evaluate the two FL-based manufacturing supplier selection models (FL-DUPR and FL-3DCNN), a dataset consisting of 3D parts with shape, material property, and quality attributes was curated. FIG. 11B shows the data preparation operation.

Supplier labels were assigned for training the classification models and for testing of supplier selection performance. The study curated and processed 1354 3D parts from the FabWave CAD repository [25′]. As shown in FIG. 11B, four steps were taken to augment the subset of FabWave data selected. For each part in a part function class (e.g., bearing, bushing, etc.), the study randomly selected a unique material from a pool of possible materials for the given function class to match a discrete part vendor's online repository (McMaster-Carr). The study then curated the material properties corresponding to the selected material from an open-source material property database (MatWeb). Similarly, the study identified the design tolerance range for a given part function class from the online repository and randomly selected and assigned a design tolerance within the range to each part. For a part function class with multiple design tolerances (e.g., flange tolerance and length tolerance for bearings), the study selected the minimum design tolerance as the limiting tolerance for the part and used it in training the model. There are also part function classes for which the online repository, such as McMaster-Carr, does not specify design tolerances. In such cases, the study used industry standards considering geometric attributes and/or material properties to assign the design tolerance to each part. For example, the modulus of miter gears and thread counts for headless screws were used to assign the design tolerance for each part within these two-part function classes, respectively. The tolerance range and its specifications were not limited to a particular industry standard. For the purpose of performance evaluation, and assignment to suppliers based on their manufacturing capabilities, we also need labels of the required manufacturing processes. Given the part function class, material properties, and design tolerance, a manufacturing process label was assigned to each part based on basic manufacturing process rules, e.g., metals are not made using injection molding, and axis-symmetric parts are not made using milling.

The study designed two distinct case studies to examine the performance of the proposed approach to supplier selection. For each case study, supplier labels of parts were attributed to one of the three suppliers based on their assumed manufacturing capabilities.

Case Study #1. In Case Study #1, the study assumed the suppliers to have no overlapping manufacturing capabilities. Specifically, the dataset of Supplier “1” consists of only parts made on a lathe, whereas the dataset for Supplier “2” contains only milled parts, and Supplier “3” only has injection-molded parts. With this strict process-based assignment of manufactured parts to suppliers, selecting a supplier in the first case is equivalent to classifying a query part by its manufacturing process. Case Study #1 was used to investigate the manufacturing process classification accuracy of the exemplary system and method in a benchmark performance evaluation.

Case Study #2. In Case Study #2, the suppliers were assumed to have overlapping manufacturing capabilities, which is more relevant in practice. Specifically, the study considered a case where supplier “1” can make parts on a lathe with a limiting design tolerance of less than 0.0254 mm, and axisymmetric injection-molded parts; supplier “2” can make turned and milled parts with a limiting design tolerance of greater than or equal to 0.0127 mm; supplier “3” has capabilities to make parts on a mill with a limiting design tolerance less than 0.0254 mm, and non-axisymmetric parts using injection molding. Because of the overlapping manufacturing capabilities, unlike Case Study #1, where each part has only one supplier label, parts in the dataset for Case Study #2 can have a maximum of two supplier labels. In other words, two suppliers can manufacture the same part. There is a difference between the ground truth label and the training label used in Case Study #2 to Case Study #1. For training, even if a part can be made by two suppliers, it is assumed that ground truth knowledge is not available at the time of training since each supplier may only have knowledge about the parts in its own proprietary dataset. Therefore, the study simulated the scenario by randomly choosing one label out of the two possible ground truth labels as the training label. For example, if the ground truth labels indicate that a part can be made by both Supplier “1” and “2,” the training label for this part is randomly selected as either Supplier “1” or Supplier “2.” However, during testing, an ideal model should predict all ground truth labels based on their manufacturing capabilities as opposed to choosing one out of many candidate suppliers with similar capabilities.

Case 1—Suppliers without Overlap in Manufacturing Capability. Case Study #1 was designed to evaluate the different FL frameworks and compare their performance in supplier selection. Based on the description of the case study, the study split the training and testing data using a 60-40 data split. Models were trained on a high-performance computing node at the Georgia Institute of Technology (PACE Phoenix Cluster with 1 NVIDIA Tesla A100 40 GB GPU). All branches of the FL-DUPR model were trained simultaneously on the training dataset. The batch size was set to 1 for training, with Adam as the optimizer [17]. The learning rates were set to 4×10⁻⁴. In total, all models were trained for 60,000 iterations on the training dataset, and the global models were merged after each iteration. The study trained a baseline DUPR model without federated learning (non-FL-DUPR), an FL-DUPR model with gradient sharing (FedSGD), and an FL-DUPR model with weight sharing (FedAvg) to compare their performance in supplier selection. Additionally, the study trained a 3D-CNN baseline model, an FL-3DCNN model with gradient sharing, and an FL-3DCNN model with weight sharing for performance comparison. The confusion matrix of accuracy for the DUPR model is obtained.

FIG. 11C shows Case Study #1 multi-class classification confusion matrices for supplier selection using (a) non-FL-DUPR, (b) gradient sharing FL-DUPR, (c) weight sharing FL-DUPR, (d) non-FL-3DCNN, (c) gradient sharing FL-3DCNN, and (f) weight sharing FL-3DCNN.

As shown in FIG. 11C, in the simplistic case where no-overlapping capabilities are considered, the 3DCNN model without federated learning performed the best as it is a proven method for multi-class classification, reaching 99% for Supplier “1,” 81% for Supplier “2,” and 99% for Supplier “3,” yielding a class-average accuracy of 93%. Here the class-average accuracy was computed by taking the sum of accuracies of suppliers and dividing by the number of suppliers. The non-FL-DUPR model trails the 3DCNN model slightly with a class-average classification accuracy of 89%. It is evident that both the gradient and weight-sharing FL approaches decrease the classification performance of the respective models due to distributed learning in FL. However, the gradient-sharing approach to training the FL-DUPR model still reached a class-average classification accuracy of 89%, which is better than the performance of the weight-sharing approach for FL-DUPR, which yielded a class-average accuracy of 83%. The result is more pronounced in the FL-3DCNN model, where the gradient-sharing approach reaches a class-average accuracy of 90.6%, while the weight-sharing approach only results in 71.6% accuracy. Based on these results, it is evident that gradient-sharing FL models are capable of reproducing the performance of the baseline non-FL models for supplier selection using our curated dataset. The observation aligns with intuition as the gradient-sharing approach is equivalent to mini-batch training of non-FL models if the local models are all initialized with the same weights. Since the optimizer state dictionaries are passed among the local models, the differences between FL-DUPR with gradient sharing and the non-FL-DUPR model are only in batch size.

In contrast, the FL-DUPR model with weight sharing simply averaged the weights of all local models, which results in significantly different models due to data distribution and the adaptive learning rate used in the Adam optimizer. Because the baseline, gradient sharing, and weight sharing models had exactly the same model architectures, the number of parameters in each model was the same, though the parameter weights were different due to the differences in training. The study then evaluated the Euclidean distance between two model layers (e.g., fully-connected layer 1 in the gradient sharing model can be compared to the fully-connected layer 1 in the weight sharing model) and obtained layer-wise distances between the two models. As shown in Table 1, the average pairwise distance of model layers between the baseline and gradient sharing is clearly lower than that of the baseline and weight-sharing models, indicating that the gradient-sharing model is more similar to the baseline non-FL model. Additionally, in Case Study #1, each supplier only has data on one type of manufacturing process, which violates the typical assumption of independent and identically distributed (IID) assumption of data. Nevertheless, the literature has shown that the weight-sharing model can achieve performance comparable to the baseline model using an optimizer without an adaptive learning rate [4′]. Assuming that a standard optimizer without an adaptive learning rate (e.g., stochastic gradient descent) is used on equally initialized model parameters, weight sharing should be equivalent to gradient sharing. In this work, one possible reason for the worse performance of the weight-sharing model is the use of the Adam optimizer, which adjusts the learning rate of each parameter based on moments of the historical gradients and yields significantly different models, as shown in Table 1.

TABLE 1
Pairwise comparison of average layer-wise Euclidean distance
between models.

| | Baseline | Gradient Sharing | Weight Sharing |
|---|---|---|---|
| Baseline | 0 | 730 | 4699 |
| Gradient Sharing | 730 | 0 | 4659 |
| Weight Sharing | 4699 | 4659 | 0 |

The architectures of the backbone models used in the study had branches for different types of inputs, namely, part shape, material properties, and tolerance. Because supplier “3” only produced parts using injection molding, which is highly dependent on material properties, the past gradients for the material property branch were different from the other two suppliers; the result may be a different adapted learning rate for the material property branch. The adaptive learning rates were not accounted for by simply averaging the weights of the model parameters, which may have resulted in a significantly worse performance overall.

Case 2—Suppliers with Overlapping Manufacturing Capabilities. Case Study #2 was designed to evaluate the ability of the FL-based models to select multiple viable manufacturing suppliers when their manufacturing capabilities overlap. In practice, almost certainly more than one shop has the manufacturing capability to make a query part. Such a problem in machine learning is typically referred to as a multilabel classification problem, where more than one label is predicted for an input object. For example, an image containing a bicycle can have both a label indicating bicycle and a label indicating wheels, which are components of the bicycle. Here, the study aimed to identify all suppliers that can produce the same query part, which in the machine learning context is equivalent to having more than one prediction as output. This task, however, is further complicated by the lack of multi-label training data due to proprietary data constraints. Again, whether a supplier has the capability to make a part (ground truth) is different from whether the supplier has made a part similar to the query part (training label). Since data sourced from each manufacturing supplier can only have one training label (as described above), the study's objective was to determine whether any of the exemplary FL models can be used to achieve a selection of all viable suppliers (multi-label prediction), given the constraint of unique training label (single-label training.)

FIG. 11D shows the result for multi-label prediction using the gradient sharing FL-DUPR and FL-3DCNN models. It is evident from the multi-label classification confusion matrices that FL-DUPR performed better than FL-3DCNN across all three suppliers. Moreover, the receiver operating characteristics (ROC, [26′]) of the respective multilabel classification tasks in FL-DUPR demonstrated a high average area under the curve (AUC) of 0.94, indicating that a wide range of thresholds can be used to achieve multilabel classification. Based on the confusion matrices, the study obtained the supplier average accuracies by taking the sum of the accuracies of suppliers and dividing by the number of suppliers. The optimized supplier-average prediction accuracy of FL-DUPR was 87.8%, whereas that of FL-3DCNN was only 65.2%. The most direct cause of the difference in performance lies in the lack of multi-label training data for FL-3DCNN. Because the underlying discriminative backbone architecture of 3DCNN aimed to learn the classification boundaries, it performed well for Case Study #1, which essentially was a classification task with defined boundaries. However, as Case Study #2 was a multi-label task with overlapping class boundaries, the FL-3DCNN simply cannot compete with the FL-DUPR, which is designed to excel for a task with overlapping capabilities. Specifically, a significant number of false negatives was observed from FL-3DCNN in Supplier 2 prediction. In other words, parts that can be made by Supplier 2 were falsely classified as not manufacturable by Supplier 2. As Supplier 2 contained the most capability overlap with Supplier 1 and Supplier 3, this result indicated that the FL-3DCNN discriminative model selected the other suppliers while ignoring the capability of Supplier 2, which could be a viable alternative supplier. The observation was supported by the findings from process-aware part retrieval [2] and automated manufacturing process classification [27], where a prior study compared the performance of embedding models with classification models for respective tasks. Even though the embedding models (FL-DUPR) may not result in better performance than classification models (FL-3DCNN) in multi-class classification tasks, the fact that the embedding model does not use labels directly in the objective function renders it more robust in more complicated manufacturing-related prediction tasks where ambiguity and multiple viable options are common.

### Discussion for Part Selection Query

Cyber manufacturing services, as envisioned, seek to connect designers with manufacturers via an internet marketplace [1]. This vision has not been realized partly due to the lack of an efficient manufacturing service search engine that identifies and ranks manufacturers capable of producing a query part design. A possible solution is to compare the similarity between the query part and previously manufactured parts in an existing database. By retrieving the most similar parts, candidate manufacturers for the query part can be identified. Group Technology (GT) was an early attempt to group various parts and products with similar design and/or production process requirements in an existing database based on standard part encoding and classification rules [2], [3]. Although GT is still used in practice, it is not fully automated and requires manual preparation of data utilizing selected encoding rules, which is prone to errors and is laborious to maintain. Furthermore, because different suppliers may choose different encoding rules, GT is also difficult to scale across different encoding systems [4].

Developed as a computationally efficient alternative to manual grouping of 3D objects, shape descriptors have been studied extensively [4]. Shape descriptors were used to convert a 3D shape into vectorial representations, from which pairwise similarity of 3D shapes could be assessed. Shape descriptors such as D2 shape distribution, spherical harmonics (SH), and heat kernel signature have shown varying levels of efficacy in automated 3D shape retrieval [5]. Recent advances in deep learning and 3D data acquisition have led to growing interest in 3D shape retrieval using deep learning methods. Deep learning methods using different 3D representations such as point cloud, multi-view images and spatial occupancy grids have also been evaluated for shape retrieval [6].

It is evident from the above that several methodologies and data representations have been used to represent and automatically retrieve 3D shapes. Such advances have useful applications in 3D data-rich domains such as design and medical scanning [7]. In the context of manufacturing, however, pure shape similarity assessment of 3D CAD models is insufficient for identifying candidate manufacturers whose production capabilities depend on other manufacturing capability information such as material properties and achievable part quality.

The instant evaluated (1) how important is including non-shape manufacturing capability information (e.g., input material properties) in part retrieval for cyber manufacturing applications? and (2) how to effectively embed both non-shape manufacturing capability information and shape information using a unified vectorial representation. The questions answered via a deep unsupervised learning-based part retrieval (DUPR) model in which both 3D part shape and material properties are embedded in the latent vector representation. The instant study assumed that the query part function and the required process can be inferred from shape and material property information, and therefore, the process and function labels were assigned to both the query and existing parts only for performance evaluation. The instant study considered process-aware part retrieval to be effective if both the manufacturing process and function class labels of retrieved parts match those of the query part. The rationale is that a candidate manufacturer should nominally have produced parts with similar functions and manufacturing process requirements. The performance of the proposed methodology was compared with a baseline supervised deep learning-based part retrieval model.

### Discussion of Supplier Selection Query

Sourcing a custom-designed part is a challenging task that often involves requesting quotes from many candidate suppliers with unknown or uncertain manufacturing capabilities. To date, designers and corporate buyers have relied on existing business relationships, word-of-mouth referrals, or an open bidding process to identify potential suppliers with the required manufacturing capabilities. Once quotes with estimated lead times are received, buyers choose the “best” matching supplier for the query part based on experience. This process can be time-consuming and requires iterative communications between suppliers and buyers to clarify part design requirements, assess manufacturability, and determine a competitive cost for the query part.

The emergence of cyber enabled platform-based manufacturing is disrupting the way discrete parts are being sourced [1′]. Prevalent on-demand manufacturing platforms generally provide instant quoting capabilities that aim to reduce the lead time for query parts. By setting the price for producing a custom part design, these platforms serve as a central hub that distributes work orders to manufacturers in its network. A supplier to the platform can then decide whether to accept or decline a requested work order based on the price and availability of the required manufacturing resources. While this workflow has simplified the task of parts sourcing for designers and corporate buyers by eliminating iterative communications with independent suppliers, the underlying assumption is that part suppliers across the spectrum have similar manufacturing capabilities, and therefore, a “one-size-fits-all” pricing strategy may be applicable. In practice, such an assumption tends to drive many specialized suppliers away from participating in a platform-based service. As many job shops serve specialized industries (medical device, energy, aerospace, automotive, etc.), the price quote generated by the platform, which serves as a broker, generally does not reflect the potentially higher manufacturing cost associated with their specialized capabilities to achieve the technical specifications of the part design.

Contrary to existing manufacturing platforms that broker the sourcing of parts assuming generic manufacturing capabilities of suppliers, the instant study envisioned a cyber manufacturing platform that caters to the uniquely specialized manufacturing capabilities of individual suppliers to enable wider adoption of cyber manufacturing-as-a-service [2′]. The vision has not been realized partly due to the lack of an efficient method to model and rank the manufacturing capabilities of suppliers for a query part design. In [2′], a deep unsupervised part retrieval model (DUPR) was developed to compare the similarity between the query part and previously manufactured parts in a shared database, where suppliers who have produced the most similar parts can be identified as candidate suppliers for the query part. In that system, the supplier has to contribute their proprietary data to the shared database to participate in the cyber manufacturing-as-a-service marketplace. While a supplier may be very interested in advertising their manufacturing capabilities, in practice, they are often prevented from doing so by prior contractual obligations or prefer not to share proprietary data, each of which limits the extent to which any design data can be publicly shared. With increasing concerns about cyber security and data access control, automated learning of the manufacturing capabilities of different suppliers in the network without direct access to their raw data that reveal explicit information about the parts they manufacture would benefit the industry.

In the era of rapidly progressing artificial intelligence (AI), user data security has sparked social debates, legislative policies, and regulations [3′]. Federated learning (FL), which was originally proposed as a framework to enable shared deep networks on decentralized user devices such as mobile phones, has been studied to establish secure cyberspace at both the device and the network levels [4′], [5′]. Since the inception of the concept of federated learning, researchers have developed several approaches to improve the performance of FL models and further preserve the privacy of user data [6′]. Chen et al. [7′] presented an asynchronous FL strategy to reduce client-server communication. Caldas et al. [8′] implemented lossy compression and federated dropout to enable users to efficiently train on smaller subsets of the global model and reduce server-to-client communication. McMahan et al. [9′] implemented a large recurrent language model with a user-level differential privacy guarantee by adding Gaussian noise. Pillutla et al. [10′] developed a robust federated aggregation approach by utilizing the geometric median in the updates of model weights to mitigate data poisoning.

More recently, FL has also permeated into industrial Internet of Things (IIoT), and manufacturing research. Deng et al. [11′] proposed FL for collaborative manufacturing, where machining parameters for aircraft structural parts can be learned using a graph-based domain-adversarial FL model. Mehta and Shao [12′] developed an FL-based defect detection method for additive manufacturing. Zhang et al. [13′] presented a deep reinforcement learning-assisted FL algorithm to manage and select highly heterogeneous data generated by IIoT equipment.

FL has evolved into a prominent collaborative learning framework that enables large-scale training and enhances data security in an industrial setting. However, it remains unknown whether an FL framework can be utilized to enable efficient supplier search while not violating the data privacy of parts in a cyber manufacturing network. The instant study provided an efficient method for searching for suppliers with manufacturing capabilities that match a given query part design by training an FL-based manufacturing capability model with decentralized data secured at individual supplier sites. Specifically, the study addressed the technical implementation of (i) identifying the best matching manufacturing supplier for a given query part design without directly accessing their raw manufacturing data, and (ii) enabling the search of manufacturing capabilities to select multiple viable suppliers if their manufacturing capabilities overlap.

Based on [2′], which demonstrated results for part retrieval by training a deep unsupervised part retrieval model (DUPR), the instant study trained an FL-based DUPR model (FL-DUPR) to enable supplier selection without directly accessing supplier data. The performance of the FL-DUPR in supplier selection was compared with a non-FL DUPR model trained on a shared dataset and an FL-based 3D CNN (FL-3DCNN) classifier in two case studies.

Additional discussion. In a cyber manufacturing marketplace, designers and corporate buyers are provided with access to a large network of suppliers to realize discrete part designs. It is necessary to guide marketplace users who have limited knowledge of manufacturing processes to identify suitable suppliers. As such, for efficient supplier search, a scalable model of manufacturing capabilities that characterize the suppliers' ability to achieve design specifications such as part shape, material properties, and quality attributes must be generated automatically. Recent literature on manufacturing capability modeling has focused on developing data-driven models to (1) classify suitable manufacturing processes, and (2) embed multimodal data for automated part retrieval. Peddireddy et al. [14′] presented a machining process identification model based on a convolutional neural network and transfer learning from a pre-trained basic feature recognition model. Wang and Rosen [15′], [16′] developed a process classification method using the Heat Kernel Signature and a point cloud-based convolutional neural network (CNN). Zhao and Melkote [17′] combined a 3D-convolutional neural network with a multilayer perceptron to learn the capability of a manufacturing process in terms of the part features, dimensional and surface quality, and the properties of materials. Angrish et al. [18′] used a multi-view convolutional neural network to achieve part retrieval based on part shape and size. Work [2′] presented an autoencoder-based multimodal embedding model that captures the shape and material properties of manufactured parts for part retrieval. It is evident that automatically extracting manufacturing capability knowledge is possible if data embodying such knowledge are available for training deep learning models.

Machine Learning. In addition to the disclosed AI/ML algorithms, other AI/ML algorithms can be employed in addition to those described herein. The term “artificial intelligence” (e.g., as used in the context of AI systems) can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model finds a pattern in the data. In a semi-supervised model, the model learns a function that maps an input (also known as a feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, and depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of a cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is a supervised classification model that classifies new data points based on similarity measures (e.g., distance functions). The k-NN classifiers are trained with a data set (also referred to herein as a “dataset”) to maximize or minimize a measure of the k-NN classifier's performance during training. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

Example Computing Device. An example computing device upon which the exemplary system and methods (e.g., for a part searcher) described herein may be implemented can include, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In a configuration, a computing device includes at least one processing unit and system memory. Depending on the exact configuration and type of computing device, system memory may be volatile (such as random access memory (RAM)), non-volatile (such as read-only memory (ROM), flash memory, etc.), or some combination of the two. The processing unit may be a programmable processor that performs arithmetic and logic operations necessary for the operation of the computing device. The computing device may also include a bus or other communication mechanism for communicating information among various components of the computing device.

Computing devices may have additional features/functionality. For example, a computing device may include additional storage, such as removable storage and non-removable storage, including, but not limited to, magnetic or optical disks or tapes. A computing device may also contain network connection(s) that allow the device to communicate with other devices. A computing device may also have input device(s) such as a keyboard, mouse, touch screen, etc. Output device(s) such as a display, speakers, printer, etc. may also be included. The additional devices may be connected to the bus in order to facilitate communication of data among the components of the computing device.

The processing unit may be configured to execute program code encoded in tangible, computer-readable media. Tangible, computer-readable media refers to any media that is capable of providing data that causes the computing device (i.e., a machine) to operate in a particular fashion. A computer-readable media may be utilized to provide instructions to processing unit 206 for execution. Example tangible, computer-readable media may include, but is not limited to, volatile media, non-volatile media, removable media, and non-removable media implemented in any method or technology for storage of information such as computer-readable instructions, data structures, program modules or other data. System memory, removable storage, and non-removable storage are all examples of tangible, computer storage media. Example tangible, computer-readable recording media include but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit may execute program code stored in the system memory. For example, the bus may carry data to the system memory, from which the processing unit receives and executes instructions. The data received by the system memory may optionally be stored on the removable storage or the non-removable storage before or after execution by the processing unit.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

### CONCLUSION

It is to be understood that the methods and systems are not limited to specific synthetic methods, specific components, or particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.

### REFERENCE LIST #1

[1] Tao F, Cheng Y, Da Xu L, Zhang L, Li B H (2014) CCIoT-CMfg: Cloud Computing and Internet of Things-based Cloud Manufacturing Service System. IEEE Transactions on Industrial Informatics 10 (2): 1435-1442.
[2] Hon K, Chi H (1994) A New Approach of Group Technology Part Families Optimization. CIRP Annals 43 (1): 425-428.
[3] Lu S C, Ham I (1989) Machine Learning Techniques for Group Technology Applications. CIRP Annals 38 (1): 455-459.
[4] Cardone A, Gupta S K, Karnik M (2003) A Survey of Shape Similarity Assessment Algorithms for Product Design and Manufacturing Applications. Journal of Computing and Information Science in Engineering 3 (2): 109-118.
[5] Tangelder J W, Veltkamp R C (2008) A Survey of Content Based 3D Shape Retrieval Methods. Multimedia Tools and Applications 39 (3): 441-471.
[6] Angrish A, Bharadwaj A, Starly B (2021) MVCNN++: Computer-Aided Design Mode Shape Classification and Retrieval using Multi-View Convolutional Neural Networks. Journal of Computing and Information Science in Engineering 21 (1): 011001.
[7] Rostami R, Bashiri F S, Rostami B, Yu Z (2019) A Survey on Data-Driven 3D Shape Descriptors. Computer Graphics Forum 38 (1): 356-393.
[8] Yan X, Melkote S (2022) Generative Modeling of the Shape Transformation Capability of Machining Processes. Manufacturing Letters 33:794-801.\
[9] Chen, S.; Guo, W. Auto-Encoders in Deep Learning-A Review with New Perspectives. Mathematics 2023, 11, 1777.

### REFERENCE LIST #2

[1′] T. A. M. Tolio, L. Monostori, J. Váncza, and O. Sauer, “Platform-based manufacturing,” CIRP Annals, vol. 72, no. 2, pp. 697-723, 2023.
[2′] X. Yan et al., “Process-aware part retrieval for cyber manufacturing using unsupervised deep learning,” CIRP annals, vol. 72, no. 1, pp. 397-400, 2023.
[3′] L. Li, Y. Fan, M. Tse, and K. Y. Lin, “A review of applications in federated learning,” Computers & Industrial Engineering, vol. 149, p. 106854, 2020.
[4′] B. McMahan, E. Moore, D. Ramage, S. Hampson, and B. A. y Arcas, “Communication-efficient learning of deep networks from decentralized data,” in Artificial intelligence and statistics, 2017: PMLR, pp. 1273-1282.
[5′] B. Ghimire and D. B. Rawat, “Recent advances on federated learning for cybersecurity and cybersecurity for federated learning for internet of things,” IEEE Internet of Things Journal, vol. 9, no. 11, pp. 8229-8249, 2022.
[6′] P. Kairouz et al., “Advances and open problems in federated learning,” Foundations and Trends in Machine Learning, vol. 14, no. 1-2, pp. 1-210, 2021.
[7′] Y. Chen, X. Sun, and Y. Jin, “Communication-efficient federated deep learning with layerwise asynchronous model update and temporally weighted aggregation,” IEEE transactions on neural networks and learning systems, vol. 31, no. 10, pp. 4229-4238, 2019.
[8′] S. Caldas, J. Konečny, H. B. McMahan, and A. Talwalkar, “Expanding the reach of federated learning by reducing client resource requirements,” arXiv preprint arXiv: 1812.07210, 2018.
[9′] H. B. McMahan, D. Ramage, K. Talwar, and L. Zhang, “Learning differentially private recurrent language models,” arXiv preprint arXiv: 1710.06963, 2017.
[10′] K. Pillutla, S. M. Kakade, and Z. Harchaoui, “Robust aggregation for federated learning,” IEEE Transactions on Signal Processing, vol. 70, pp. 1142-1154, 2022.
[11′] T. Deng, Y. Li, X. Liu, and L. Wang, “Federated learning-based collaborative manufacturing for complex parts,” Journal of Intelligent Manufacturing, vol. 34, no. 7, pp. 3025-3038, 2023.
[12′] M. Mehta and C. Shao, “Federated learning-based semantic segmentation for pixel-wise defect detection in additive manufacturing,” Journal of Manufacturing Systems, vol. 64, pp. 197-210, 2022.
[13′] P. Zhang, C. Wang, C. Jiang, and Z. Han, “Deep reinforcement learning assisted federated learning algorithm for data management of IIoT,” IEEE Transactions on Industrial Informatics, vol. 17, no. 12, pp. 8475-8484, 2021.
[14′] D. Peddireddy et al., “Identifying manufacturability and machining processes using deep 3D convolutional networks,” Journal of Manufacturing Processes, vol. 64, pp. 1336-1348, 2021.
[15′] Z. Wang and D. Rosen, “Manufacturing process classification based on heat kernel signature and convolutional neural networks,” Journal of Intelligent Manufacturing, vol. 34, no. 8, pp. 3389-3411, 2023.
[16′] Z. Wang and D. Rosen, “Manufacturing process classification based on distance rotationally invariant convolutions,” Journal of Computing and Information Science in Engineering, vol. 23, no. 5, p. 051004, 2023.
[17′] C. Zhao and S. N. Melkote, “Learning the manufacturing capabilities of machining and finishing processes using a deep neural network model,” Journal of Intelligent Manufacturing, pp. 1-21, 2023.
[18′] A. Angrish, A. Bharadwaj, and B. Starly, “MVCNN++: computer-aided design model shape classification and retrieval using multi-view convolutional neural networks,” Journal of Computing and Information Science in Engineering, vol. 21, no. 1, p. 011001, 2021.
[19′] S. Banabilah, M. Aloqaily, E. Alsayed, N. Malik, and Y. Jararweh, “Federated learning review: Fundamentals, enabling technologies, and future applications,” Information processing & management, vol. 59, no. 6, p. 103061, 2022.
[20′] D. P. Kingma and J. Ba, “Adam: A method for stochastic optimization,” arXiv preprint arXiv: 1412.6980, 2014.
[21′] J. Wu, C. Zhang, T. Xue, B. Freeman, and J. Tenenbaum, “Learning a probabilistic latent space of object shapes via 3d generative-adversarial modeling,” Advances in neural information processing systems, vol. 29, 2016.
[22′] A. Radford, L. Metz, and S. Chintala, “Unsupervised representation learning with deep convolutional generative adversarial networks,” arXiv preprint arXiv: 1511.06434, 2015.
[23′] E. J. Smith and D. Meger, “Improved adversarial systems for 3d object generation and reconstruction,” in Conference on Robot Learning, 2017: PMLR, pp. 87-96.
[24′] D. Maturana and S. Scherer, “Voxnet: A 3d convolutional neural network for real-time object recognition,” in 2015 IEEE/RSJ international conference on intelligent robots and systems (IROS), 2015: IEEE, pp. 922-928.
[25′] A. Bharadwaj, Y. Xu, A. Angrish, Y. Chen, and B. Starly, “Development of a pilot manufacturing cyberinfrastructure with an information rich mechanical CAD 3D model repository,” in International Manufacturing Science and Engineering Conference, 2019, vol. 58745: American Society of Mechanical Engineers, p. V001T02A035.
[26′] A. P. Bradley, “The use of the area under the ROC curve in the evaluation of machine learning algorithms,” Pattern recognition, vol. 30, no. 7, pp. 1145-1159, 1997.
[27′] X. Yan and S. Melkote, “Automated manufacturability analysis and machining process selection using deep generative model and Siamese neural networks,” Journal of Manufacturing Systems, vol. 67, pp. 57-67, 2023.

What is claimed is:

1. A system comprising:
a processor; and
a memory having instructions stored thereon, wherein execution of the instructions by the processor causes the processor to execute a part retrieval search by executing a set of processes to:
receive a model of a part and manufacturability-associated data for the part;
performing a similarity search for shape and manufacturability-associated metrics via a trained AI model of the received model against a database of parts embedded within the trained AI model to identify a set of candidate models, wherein the trained AI model was trained on both part shape and manufacturability-associated data of parts in the database and is configured to output a set of candidate models and/or predictive value of likelihood that a manufacturer associated with the set of candidate part models could manufacture the received model;
causing the set of candidate models and/or the predictive value of the likelihood the manufacturer is able to manufacture the part model to be presented in a graphical user interface or to a report.

2. The system of claim 1, wherein the trained AI model was trained on material properties that include at least one material property, such as a density parameter, a tensile strength parameter, and a melting point parameter.

3. The system of claim 1, wherein the trained AI model was trained on shapes that include at least one of a bearing, a bushing, a gear, a shaft collar, a gear rack, a screw, a shaft, and a key produced by one or more manufacturing processes.

4. The system of claim 1, wherein the trained AI model was trained via a first encoding network associated with the part shape and a second encoding network associated with the material properties, wherein the first and second encoding networks are connected by a fully connected linear layer.

5. The system of claim 1, wherein the trained AI model was additionally trained on a part property, wherein the similarity search of the shape and manufacturability-associated data includes a search of a property value defined in the manufacturability-associated data.

6. The system of claim 1, wherein the execution of the instructions further causes the processor to:
update the trained AI model by re-training the trained AI model with local data.

7. The system of claim 1, wherein the execution of the instructions further causes the processor to:
update the trained AI model with local data as a local AI model with updated configurations, wherein the updated configurations are transmitted to another system for global learning for a federated AI model that includes the trained AI model and trained AI models of other systems.

8. The system of claim 1, wherein the execution of the instructions further causes the processor to:
receive (i) an updated AI model or (ii) AI model configurations to update the trained AI model.

9. The system of claim 1, wherein the execution of the instructions further causes the processor to:
receive (i) an updated AI model or (ii) AI model configurations to update the trained AI model as a local AI model with updated configurations, wherein the updated configurations are transmitted to another system for global learning for a federated AI model that includes the trained AI model and trained AI models executed at other systems.

10. The system of claim 1, wherein the system is implemented in cloud infrastructure.

11. The system of claim 1, wherein the system is implemented as a remote server.

12. The system of claim 1, wherein the execution of instructions further causes the processor to:
receive a database of parts over a web interface; and
retrain the trained AI model using the received database.

13. A method comprising:
receiving a model of a part and manufacturability-associated data for the part;
performing a similarity search for shape and manufacturability-associated metric via a trained AI model of the received model against a database of parts embedded within the trained AI model, to identify a set of candidate models, wherein the trained AI model was trained on both part shape and manufacturability-associated data of parts in the database and is configured to output a set of candidate models and/or predictive value of likelihood that a manufacturer associated with the set of candidate part models could manufacture the received model; and
causing the set of candidate models and/or the predictive value of the likelihood the manufacturer is able to manufacture the part model to be presented in a graphical user interface or to a report.

14. The method of claim 13, wherein the trained AI model was trained (i) on material properties that include at least one material property such as a density parameter, a tensile strength parameter, and a melting point parameter or (ii) on shapes that includes at least one of a bearing, a bushing, a gear, a shaft collar, a gear rack, a screw, a shaft, and a key produced by one or more manufacturing processes.

15. The method of claim 14, wherein the trained AI model was additionally trained on a part property, wherein the similarity search of the shape and manufacturability-associated data includes a search of a property value defined in the manufacturability-associated data.

16. The method of claim 13 further comprising:
updating the trained AI model by re-training the trained AI model with (i) local data or (ii) data received from an external database.

17. The method of claim 13 further comprising:
updating the trained AI model with local data as a local AI model with updated configurations, wherein the updated configurations are transmitted to another system for global learning for a federated AI model that includes the trained AI model and trained AI models of other systems.

18. The method of claim 13 further comprising:
receiving (i) an updated AI model or (ii) AI model configurations.

19. The method of claim 13 further comprising:
receiving (i) an updated AI model or (ii) AI model configurations to update the trained AI model as a local AI model with updated configurations, wherein the updated configurations are transmitted to another system for global learning for a federated AI model that includes the trained AI model and trained AI models executed at other systems.

20. A method of training a machine learning operator, the method comprising:
providing an AI model;
inputting a set of shapes to a first portion of an AI model, the first portion being associated with a part shape;
inputting at least one corresponding manufacturability-associated data to a second portion of the AI model, the second portion of the AI model being associated with manufacturability-associated data, wherein the first and second encoding networks are connected, at least in part, by a fully connected latent layer; and
generating a metric for likelihood evaluation based on the autoencoder.
